(19) United States
(12) Patent Application Publication
(10) Pub. No.: US 2025/0184015 A1
(43) Pub. Date: Jun. 5, 2025

(54) PROFILING AND SIGNALING FOR CLUTTER DOPPLER CHARACTERISTICS IN RF SENSING

(71) Applicant: QUALCOMM Incorporated, San Diego, CA (US)

(72) Inventors: Mohammed Ali Mohammed HIRZALLAH, San Marcos, CA (US); Srinivas YERRAMALLI, San Diego, CA (US); Marwen ZORGUI, San Diego, CA (US)

(21) Appl. No.: 18/529,819

(22) Filed: Dec. 5, 2023

(51) Int. Cl. H04B 17/20; H04B 17/27; H04L 5/00; H04W 8/22

(52) U.S. Cl. CPC H04B 17/253; H04B 17/27; H04L 5/0051; H04W 8/22

(57) ABSTRACT

In some implementations, a configuring device may send, to a sensing node set comprising one or more sensing nodes communicatively coupled with a wireless network, a sensing configuration, wherein the sensing configuration is configured to enable the sensing node set to perform a radio frequency (RF) sensing procedure and obtain clutter Doppler measurement information of the geographical area based at least in part on the RF sensing procedure. The configuring device may receive, from the sensing node set the clutter Doppler measurement information. The configuring device may determine a profile of the clutter Doppler characteristics of the geographical area based at least in part on the clutter Doppler measurement information.

### BACKGROUND

### 1. Field of Disclosure

The present disclosure relates generally to the field of radio frequency (RF) sensing, and more specifically to clutter Doppler in RF sensing.

### 2. Description of Related Art

The performance of RF sensing by wireless devices can have a wide range of consumer, industrial, commercial, military, and other applications. RF sensing can be used to determine the presence of a target object, determining a location of the target object, and/or track the movement of the target object over time. Cellular networks (e.g., fifth-generation (5G) new radio (NR) networks) may be capable of performing RF sensing using base stations, user equipments (UEs), and/or other wireless devices communicatively coupled with the cellular network as “sensing nodes.” In addition to target objects that are intended to be detected using RF sensing, other objects, including moving objects, may be detected.

### BRIEF SUMMARY

An example method of profiling clutter Doppler characteristics of a geographical area for radio frequency (RF) sensing by sensing nodes communicatively coupled with a wireless network, according to this disclosure, may comprise sending, from a configuring device to a sensing node set comprising one or more sensing nodes communicatively coupled with the wireless network, a sensing configuration, wherein the sensing configuration is configured to enable the sensing node set to perform an RF sensing procedure and obtain clutter Doppler measurement information of the geographical area based at least in part on the RF sensing procedure. The method also may comprise receiving, at the configuring device from the sensing node set the clutter Doppler measurement information. The method also may comprise determining, with the configuring device, a profile of the clutter Doppler characteristics of the geographical area based at least in part on the clutter Doppler measurement information.

An example method of profiling clutter Doppler characteristics of a geographical area for radio frequency (RF) sensing by sensing nodes communicatively coupled with a wireless network, according to this disclosure, may comprise receiving, at a sensing node communicatively coupled with the wireless network, a sensing configuration from a configuring device. The method also may comprise performing, with the sensing node while the sensing node is in the geographical area, an RF sensing procedure with the sensing node in accordance with the sensing configuration. The method also may comprise obtaining, with the sensing node, clutter Doppler measurement information of the geographical area based at least in part on the RF sensing procedure. The method also may comprise reporting, with the sensing node, the clutter Doppler measurement information to the configuring device.

An example method of using a profile of clutter Doppler characteristics of a geographical area for radio frequency (RF) sensing by a sensing node communicatively coupled with a wireless network, according to this disclosure, may comprise obtaining, at a sensing node communicatively coupled with the wireless network in the geographical area, sensing assistance data indicative of the profile of clutter Doppler characteristics of the geographical area. The method also may comprise performing, with the sensing node while the sensing node is in the geographical area, an RF sensing procedure. The method also may comprise detecting, based at least in part on the RF sensing procedure and the profile of clutter Doppler characteristics, one or more objects in the geographical area.

An example configuring device for profiling clutter Doppler characteristics of a geographical area for radio frequency (RF) sensing by sensing nodes communicatively coupled with a wireless network, according to this disclosure, may comprise one or more transceivers, one or more memories, one or more processors communicatively coupled with the one or more transceivers and the one or more memories, wherein the one or more processors are configured to send, via the one or more transceivers to a sensing node set comprising one or more sensing nodes communicatively coupled with the wireless network, a sensing configuration, wherein the sensing configuration is configured to enable the sensing node set to perform an RF sensing procedure and obtain clutter Doppler measurement information of the geographical area based at least in part on the RF sensing procedure. The one or more processors further may be configured to receive, via the one or more transceivers from the sensing node set the clutter Doppler measurement information. The one or more processors further may be configured to determine a profile of the clutter Doppler characteristics of the geographical area based at least in part on the clutter Doppler measurement information.

An example sensing node for profiling clutter Doppler characteristics of a geographical area for radio frequency (RF) sensing by sensing nodes communicatively coupled with a wireless network, according to this disclosure, may comprise one or more transceivers, one or more memories, one or more processors communicatively coupled with the one or more transceivers and the one or more memories, wherein the one or more processors are configured to receive, via the one or more transceivers, a sensing configuration from a configuring device. The one or more processors further may be configured to perform an RF sensing procedure with the sensing node in accordance with the sensing configuration while the sensing node is in the geographical area. The one or more processors further may be configured to obtain clutter Doppler measurement information of the geographical area based at least in part on the RF sensing procedure. The one or more processors further may be configured to report, via the one or more transceivers, the clutter Doppler measurement information to the configuring device.

An example sensing node for using a profile of clutter Doppler characteristics of a geographical area for radio frequency (RF) sensing, according to this disclosure, may comprise one or more transceivers, one or more memories, one or more processors communicatively coupled with the one or more transceivers and the one or more memories, wherein the one or more processors are configured to obtain sensing assistance data indicative of the profile of clutter Doppler characteristics of the geographical area. The one or more processors further may be configured to perform an RF sensing procedure with the sensing node while the sensing node is in the geographical area. The one or more processors further may be configured to detect, based at least in part on the RF sensing procedure and the profile of clutter Doppler characteristics, one or more objects in the geographical area.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning/sensing system, according to an embodiment.

FIG. 2 is a diagram of a fifth generation (5G) new radio (NR) positioning/sensing system, according to an embodiment.

FIG. 3 is a diagram showing an example of a RF sensing system.

FIG. 4 is an example scenario in which RF sensing may be performed.

FIG. 5 is a message flow diagram of an example process by which clutter Doppler characteristics of a geographical area for RF sensing may be profiled, according to an embodiment.

FIG. 6 is a message flow diagram of an example process by which a clutter Doppler profile of a geographical area may be obtained and used by one or more sensing nodes to perform RF sensing in the geographical area, according to an embodiment.

FIG. 7 is a flow diagram of a method of profiling clutter Doppler characteristics of a geographical area for RF sensing by sensing nodes communicatively coupled with a wireless network, according to an embodiment.

FIG. 8 is a flow diagram of a method of profiling clutter Doppler characteristics of a geographical area for RF sensing by sensing nodes communicatively coupled with a wireless network, according to an embodiment.

FIG. 9 is a flow diagram of a method of using a profile of clutter Doppler characteristics of a geographical area for RF sensing by a sensing node communicatively coupled with a wireless network, according to an embodiment.

FIG. 10 is a block diagram of an embodiment of a mobile sensing node.

FIG. 11 is a block diagram of an embodiment of a stationary sensing node.

FIG. 12 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

As used herein, the terms “RF sensing,” “passive RF sensing,” and variants refer to a process by which one or more objects are detected using RF signals transmitted by a transmitting device and, after reflecting from the one or more objects, received by a receiving device. In a monostatic configuration, the transmitting and receiving device are the same device. In a bistatic configuration one device transmits RF signals, and another device receives reflections of the RF signals from one or more objects. In multi-static configuration, one or more receiving devices are separate from one or more transmitting devices. As used herein, the term “static” in the terms “monostatic,” “bistatic,”, and “multistatic,” are meant to conform with historical literature on RF sensing, but are not limited to “static” or stationary sensing nodes. As described herein, in some embodiments, sensing nodes may be mobile. As described herein, devices performing RF sensing may be referred to as “RF sensing nodes” or simply “sensing nodes.” In a bistatic or multi-static configuration, transmitting devices may be referred to as “transmitting nodes” or “Tx nodes,” and receiving devices may be referred to as “receiving nodes” or “Rx nodes.” As described hereafter in more detail, a receiving device can make measurements of these reflected RF signals to determine one or more characteristics of the one or more objects, such as location, range, angle, direction, orientation, Doppler, velocity, etc. According to some embodiments, RF sensing may be “passive” in that no RF signals need to be transmitted by the receiving device or one or more objects for the one or more objects to be detected.

Additionally, unless otherwise specified, references to “reference signals” and the like may be used to refer to signals used for positioning of a user equipment (UE), sensing of active and/or passive objects by one or more sensing nodes, or a combination thereof. As described in more detail herein, such signals may comprise any of a variety of signal types. This may include, but is not limited to, a positioning reference signal (PRS), sounding reference signal (SRS), synchronization signal block (SSB), channel start information reference signal (CSI-RS), or any combination thereof.

Techniques provided herein may apply to “mmWave” technologies, which typically operate at 57-71 GHz, but may include frequencies ranging from 30-300 GHz. This includes, for example, frequencies utilized by the 802.11ad Wi-Fi standard (operating at 60 GHZ). That said, some embodiments may utilize RF sensing with frequencies outside this range. For example, in some embodiments, 5G NR frequency bands (e.g., 28 GHZ) may be used. Because RF sensing may be performed in the same bands as communication, hardware may be utilized for both communication and RF sensing. For example, one or more of the components of an RF sensing system as described herein may be included in a wireless modem (e.g., Wi-Fi or NR modem), a UE (e.g., an extended device), or the like. Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the RF sensing system may be capable of sending RF signals for communication (e.g., using 802.11 or NR wireless technology), embodiments may leverage channel estimation and/or other communication-related functions for providing RF sensing functionality as described herein. Accordingly, the pulses may be the same as those used in at least some aspects of wireless communication.

Various aspects relate generally to the field of RF-based sensing in a wireless network. Some aspects more specifically relate to profiling clutter Doppler characteristics of the geographical area to enable more efficient RF sensing of an RF target in the geographical area. Some examples include a configuring device, such as a server, configuring one or more RF sensing nodes in the geographical area to obtain RF sensing measurements indicative of clutter Doppler characteristics of the geographical area, and reporting the clutter Doppler characteristics to the configuring device. The server may then use this information, optionally with historical clutter Doppler characteristics of the geographical area, to determine a profile of clutter Doppler characteristics of the geographical area. The configuring device may subsequently provide the profile of clutter Doppler characteristics of the geographical area to one or more RF sensing nodes in the geographical area to help improve the accuracy of RF sensing. According to some embodiments, the configuring device and RF sensing nodes may be communicatively coupled with a wireless communication network, such as a cellular network. In some embodiments, the RF sensing nodes may comprise user equipments (UEs) and/or base stations (e.g., eNBs, gNBs, etc.) of a cellular network, and/or the configuring device may comprise a server (e.g., location server and/or sensing server) of the cellular network.

Particular aspects of the subject matter described in this disclosure can be implemented to realize one or more of the following potential advantages. In some examples, by creating and sharing a profile of clutter Doppler characteristics of the geographical area with RF sensing nodes in the geographical area, embodiments may improve the accuracy of RF sensing by increasing the effectiveness of clutter Doppler filtration. Put differently, one or more targets of the RF sensing may be more easily detected by the RF sensing once clutter Doppler information obtained during RF sensing is identified and filtered. The profile of clutter Doppler characteristics can facilitate this filtration process during the processing of RF sensing information. This and other advantages will be apparent to persons of ordinary skill in light of the disclosed embodiments detailed hereafter. A discussion of embodiments is provided after a brief discussion of relevant technology and context/background in which embodiments may be used.

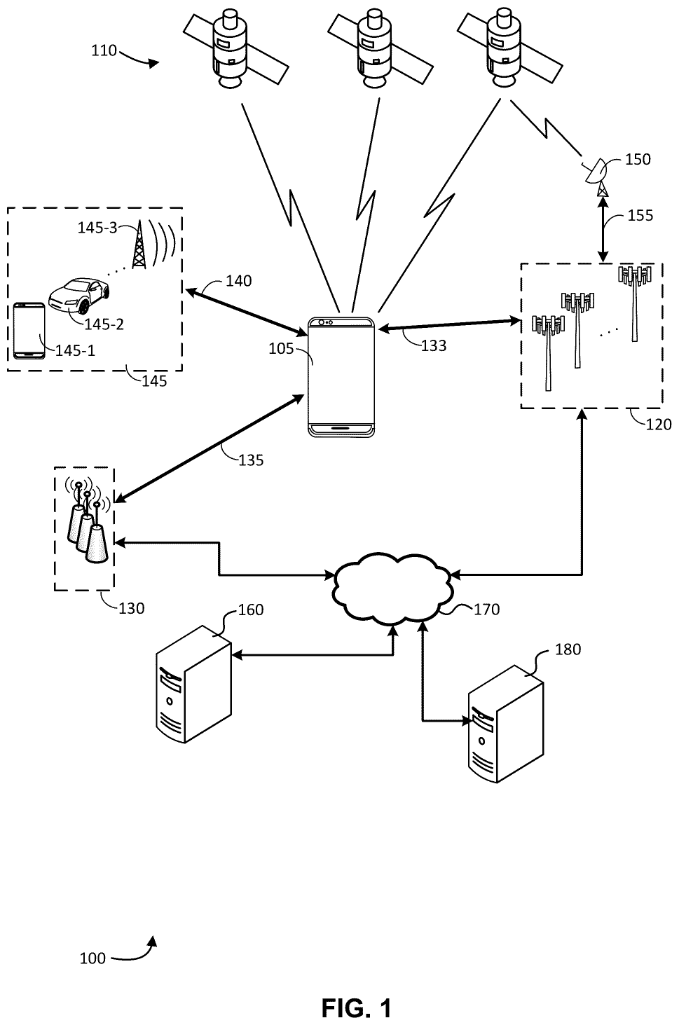

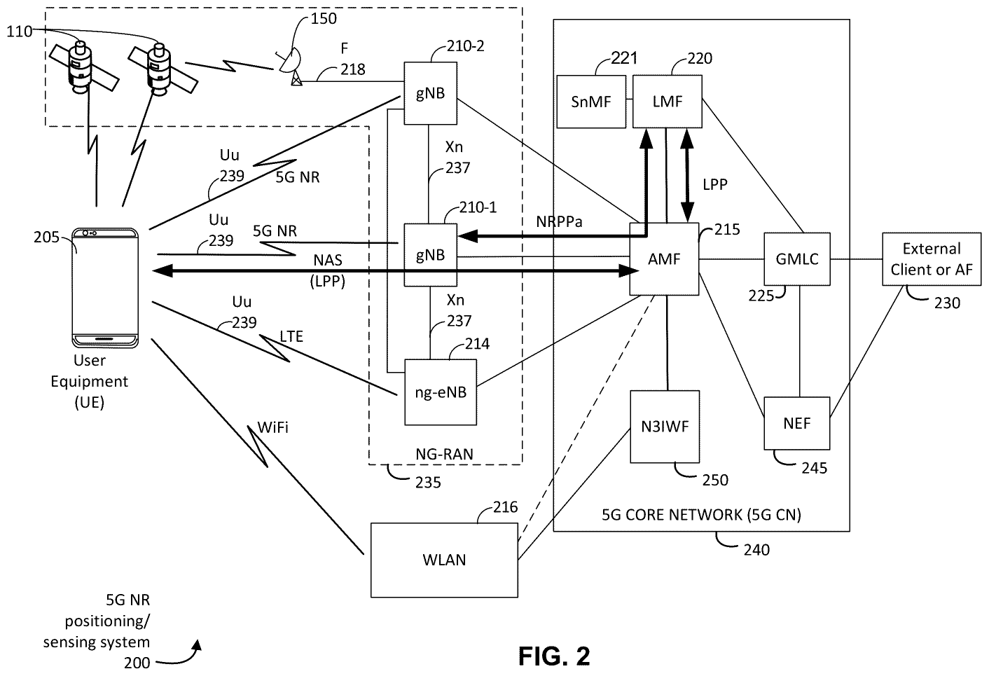

FIG. 1 is a simplified illustration of a positioning/sensing system 100, which may be implemented in conjunction with and/or as part of a wireless communication system (e.g., cellular communication network) which a mobile device 105, location/sensing server 160, and/or other components of the positioning/sensing system 100 can use the techniques provided herein for determining and/or using a clutter Doppler profile RF sensing in a geographical area, according to an embodiment. The techniques described herein may be implemented by one or more components of the positioning/sensing system 100, however the techniques described herein are not limited to such components and may be implemented in other types of systems (not shown). The positioning/sensing system 100 can include: a mobile device 105; one or more satellites 110 (also referred to as space vehicles (SVs)) for a Global Navigation Satellite System (GNSS) (such as the Global Positioning System (GPS), GLONASS, Galileo or Beidou) and/or NTN functionality; base stations 120; access points (APs) 130; location/sensing server 160; network 170; and external client 180. Generally put, the positioning/sensing system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices). Additional details regarding particular location estimation/sensing techniques are discussed with regard to FIG. 2.

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the positioning/sensing system 100. Similarly, the positioning/sensing system 100 may include a larger or smaller number of base stations 120 and/or APs 130 than illustrated in FIG. 1. The illustrated connections that connect the various components in the positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location/sensing server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). In an LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location/sensing server 160, by accessing the network 170 via a base station 120 using a first communication link 133. Additionally or alternatively, because APs 130 also may be communicatively coupled with the network 170, mobile device 105 may communicate with network-connected and Internet-connected devices, including location/sensing server 160, using a second communication link 135, or via one or more other mobile devices 145. As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” used herein may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the mobile device 105 to communicate with the network 170 via satellites 110, but this can also enable network-based positioning, RF sensing, etc.

Satellites 110 may be utilized in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location/sensing server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location/sensing server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location/sensing server 160. In some embodiments, the location/sensing server 160 may comprise, a Discovered SLP (D-SLP) or an Emergency SLP (E-SLP). The location/sensing server 160 may also comprise an Enhanced Serving Mobile Location Center (E-SMLC) that supports location of mobile device 105 using a control plane (CP) location solution for LTE radio access by mobile device 105. The location/sensing server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location/sensing server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning/sensing system 100 (e.g., satellites 110, APs 130, base stations 120). The estimated location of the mobile device 105 can be estimated geometrically (e.g., using multiangulation and/or multilateration), based on the distance (range) and/or angle measurements, along with known position of the one or more components.

Additionally or alternatively, the location/sensing server 160, may function as a sensing server. A sensing server can be used to coordinate and/or assist in the coordination of sensing of one or more objects (also referred to herein as “targets”) by one or more wireless devices in the positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SnMF or SMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra-Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, cast or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

As previously noted, the example positioning/sensing system 100 can be implemented using a wireless communication network, such as an LTE-based or 5G NR-based network, or a future 6G network. FIG. 2 shows a diagram of a 5G NR positioning/sensing system 200, illustrating an embodiment of a positioning/sensing system (e.g., positioning/sensing system 100) implemented in 5G NR. The 5G NR positioning/sensing system 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216 to implement one or more positioning methods. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR positioning/sensing system 200 additionally may be configured to determine the location of a UE 205 by using an LMF 220 (which may correspond with location/sensing server 160) to implement the one or more positioning methods. The SnMF 221 may coordinate RF sensing by the 5G NR positioning/sensing system 200. Here, the 5G NR positioning/sensing system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning/sensing system 200 are described below. The 5G NR positioning/sensing system 200 may include additional or alternative components.

The 5G NR positioning/sensing system 200 may further utilize information from satellites 110. As previously indicated, satellites 110 may comprise GNSS satellites from a GNSS system like Global Positioning/sensing system (GPS) or similar system (e.g. GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNBs 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR positioning/sensing system 200. Similarly, the 5G NR positioning/sensing system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning/sensing system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning/sensing system 200, such as the LMF 220 and AMF 215.

5G NR positioning/sensing system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations, and may also include NTN satellites 110. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214, WLAN 216, or NTN satellite 110.

In some embodiments, an access node, such as a gNB 210, ng-eNB 214, WLAN 216, or NTN satellite 110, or a combination thereof, (alone or in combination with other components of the 5G NR positioning/sensing system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, WLAN 216, or NTN satellite 110) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such gNB 210, ng-eNB 214, WLAN 216, or NTN satellite 110, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable the secure provision of information from the external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE-based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location-related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location-related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE-assisted or UE-based positioning of UE 205 by LMF 220.

In a 5G NR positioning/sensing system 200, positioning and sensing methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), RSTD, Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for GNSS satellites), WLAN, etc.

With a UE-based position method, UE 205 may obtain location measurements (e.g., which may be the same as or similar to location measurements for a UE-assisted position method) and may further compute a location of UE 205 (e.g., with the help of assistance data received from a location server such as LMF 220, an SLP, or broadcast by gNBs 210, ng-eNB 214, or WLAN 216).

With a network-based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, which is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

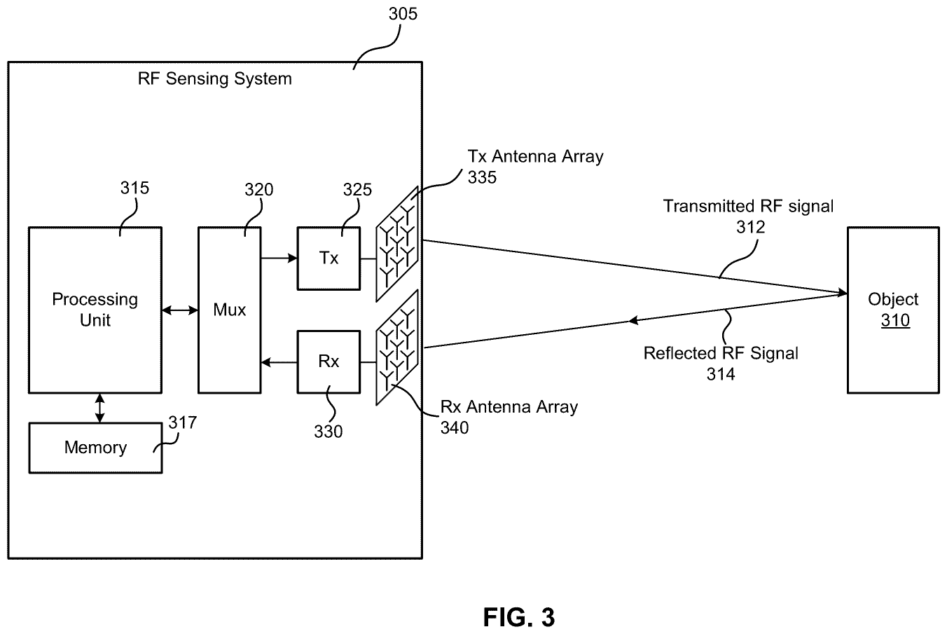

The principles described above with respect to UE-assisted positioning, UE-based positioning, UL-based positioning, DL-based positioning, and DL-UL based positioning may be generally extended to RF sensing. That is, RF sensing may be UE-based (e.g., originated from the UE) and/or UE assisted (e.g., originated from a non-UE entity), and may involve UL signals, DL signals, or both. However, RF sensing may differ from positioning in various ways. For example, as previously noted, RF sensing may involve the use of positioning reference signal (PRS), sounding reference signal (SRS), synchronization signal block (SSB), channel start information reference signal (CSI-RS), or any combination thereof. Further, RF sensing may be performed in a monostatic, bistatic, or multi-static manner, as described above, where RF sensing nodes comprise a UE (e.g., UE 205) and/or one or more access nodes (e.g., gNBs 210, ng-eNB 214, WLAN 216, NTN satellites 110, or any combination thereof). Various aspects of RF sensing is described below FIG in more detail with respect to FIG. 3.

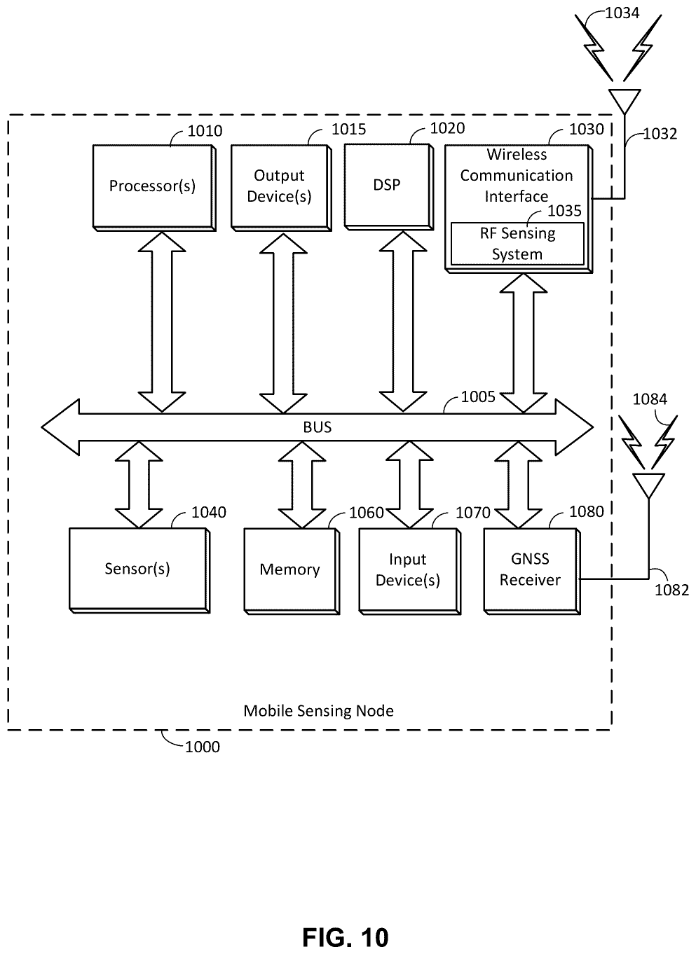

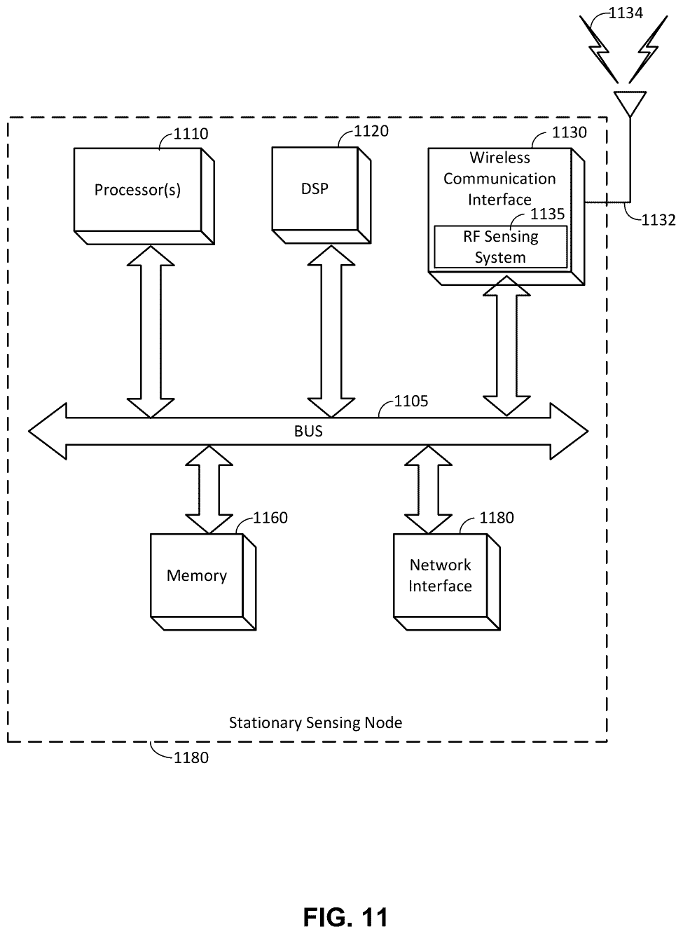

FIG. 3 is a diagram showing an example of an RF sensing system 305 and associated terminology. As used herein, the terms “waveform” and “sequence” and derivatives thereof are used interchangeably to refer to RF signals generated by a transmitter of the RF sensing system and received by a receiver of the RF sensing system for object detection. A “pulse” and derivatives thereof are generally referred to herein as waveforms comprising a sequence or complementary pair of sequences transmitted and received to generate a CIR. The RF sensing system 305 may comprise a standalone device or may be integrated into a larger electronic device (e.g., the UE disclosed herein), such as a mobile phone, a base station/access node, a satellite, or other device, which may be referred to herein as a “RF sensing node.” (Example components of such electronic devices are illustrated in FIGS. 10 and 11, discussed in detail hereafter.) It can be noted that although the example RF sensing system 305 of FIG. 3 is illustrated in a monostatic configuration, embodiments are not so limited. As noted elsewhere herein, RF sensing nodes may be configured to perform RF sensing in a monostatic, bistatic, or multi-static configuration, or any combination thereof (e.g., depending on the circumstances of a particular instance). As such, components of an RF sensing system 305 within an RF sensing node may vary. For example, RF sensing nodes performing only transmitting or only receiving during RF sensing may include only respective components related to the transmitting or receiving. Again, embodiments may vary, depending on desired functionality.

With regard to the functionality of the RF sensing system 305 in FIG. 3, the RF sensing system 305 can detect the distance, direction, and/or speed of objects of an object 310 by generating a series of transmitted RF signals 312 (comprising one or more pulses). Some of these transmitted RF signals 312 reflect off of the object 310, and these reflected RF signals 314 (or “echoes”) are then processed by the RF sensing system 305 using beamforming (BF) and digital signal processing (DSP) techniques to determine the object's location (azimuth, elevation, velocity (e.g., from Doppler measurements), and range) relative to the RF sensing system 305.

To enable RF sensing, RF sensing system 305 may include a processing unit 315, memory 317, multiplexer (mux) 320, Tx processing circuitry 325, and Rx processing circuitry 330. (The RF sensing system 305 may include additional components not illustrated, such as a power source, user interface, or electronic interface). It can be noted, however, that these components of the RF sensing system 305 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 312. Likewise, the terms “receive circuitry” or “Rx circuitry” refer to any circuitry utilized to detect and/or process the reflected RF signal 314. As such, “transmit circuitry” and “receive circuitry” may not only comprise the Tx processing circuitry 325 and Rx processing circuitry 330 respectively but may also comprise the mux 320 and processing unit 315. In some embodiments, the processing unit may compose at least part of a modem and/or wireless communications interface. In some embodiments, more than one processing unit may be used to perform the functions of the processing unit 315 described herein.

The Tx processing circuitry 325 and Rx circuitry 330 may comprise subcomponents for respectively generating and detecting RF signals. As a person of ordinary skill in the art will appreciate, the Tx processing circuitry 325 may therefore include a pulse generator, digital-to-analog converter (DAC), a mixer (for up-mixing the signal to the transmit frequency), one or more amplifiers (for powering the transmission via Tx antenna array 335), etc. The Rx processing circuitry 330 may have similar hardware for processing a detected RF signal. In particular, the Rx processing circuitry 330 may comprise an amplifier (for amplifying a signal received via Rx antenna 340), a mixer for down-converting the received signal from the transmit frequency, an analog-to-digital converter (ADC) for digitizing the received signal, and a pulse correlator providing a matched filter for the pulse generated by the Tx processing circuitry 325. The Rx processing circuitry 330 may therefore use the correlator output as the CIR, which can be processed by the processing unit 315 (or other circuitries). Processing of the CIR may include object detecting, range, speed, or direction of arrival (DoA) estimation.

Beamforming is further enabled by a Tx antenna array 335 and Rx antenna array 340. Each antenna array 335, 340 comprises a plurality of antenna elements. It can be noted that, although the antenna arrays 335, 340 of FIG. 3 include two-dimensional arrays, embodiments are not so limited. Arrays may simply include a plurality of antenna elements along a single dimension that provides for spatial cancellation between the Tx and Rx sides of the RF sensing system 305. As a person of ordinary skill in the art will appreciate, the relative location of the Tx and Rx sides, in addition to various environmental factors can impact how spatial cancellation may be performed.

It can be noted that the properties of the transmitted RF signal 312 may vary, depending on the technologies utilized. Techniques provided herein can apply generally to “mmWave” technologies, which typically operate at 57-71 GHz, but may include frequencies ranging from 30-300 GHz. This includes, for example, frequencies utilized by the 802.11ad Wi-Fi standard (operating at 60 GHZ). That said, some embodiments may utilize RF signals with frequencies outside this range. For example, in some embodiments, 5G frequency bands (e.g., 28 GHZ) may be used.

Because RF sensing may be performed in the same frequency bands as communication (e.g., cellular and/or WLAN communication), hardware may be utilized for both communication and RF sensing, as previously noted. For example, one or more of the components of the RF sensing system 305 shown in FIG. 3 may be included in a wireless modem (e.g., Wi-Fi, 5G, or other modems). Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the RF sensing system may be capable of sending RF signals for communication (e.g., using 802.11 communication technology), embodiments may leverage channel estimation used in communication for performing the RF sensing as provided herein. Accordingly, the pulses may be the same as those used for channel estimation in communication.

As noted, the RF sensing system 305 may be integrated into an electronic device in which RF sensing is desired. For example, the RF sensing system 305, which can perform RF sensing, may be part of communication hardware found in modern mobile phones. Other devices, too, may utilize the techniques provided herein. These can include, for example, other mobile devices (e.g., tablets, portable media players, laptops, wearable devices, other electronic devices (e.g., security devices, on-vehicle systems, specialized or dedicated RF sensing devices), wireless nodes of the communication network (e.g., access nodes, such as base stations and/or satellites), or the like. That said, electronic devices (e.g., RF sensing nodes) into which an RF sensing system 305 may be integrated are not limited to such devices.

In RF sensing, a wireless signal can be transmitted from one or multiple transmit points and received at one or multiple receive points after being reflected off a target. RF sensing can enable many candidate applications, including intruder detection, animal/pedestrian/unmanned aerial vehicle (UAV) intrusion detection in highways and railways, rainfall monitoring, flooding awareness, autonomous driving, automated guided vehicle (AGV) detection/tracking/collision avoidance, smart parking and assistance, UAV trajectory and tracking, crowd management, sleep/health monitoring, gesture recognition, XR streaming, public safety, search and rescue, and more. Further, RF sensing is expected to be incorporated into wireless standards (e.g., 6G), and therefore may be performed in the future in a cellular network.

RF sensing of objects may be complicated by “clutter” in the environment. Unlike the simplified example in FIG. 3, a sensing signal can also reflect off other non-target objects, or objects that are not intended to be detected. These non-target objects may be referred to as “clutter sources.” Because clutter can have comparable or stronger reflection than target echoes, clutter can degrade target detection in RF sensing. To detect moving targets (e.g., using a moving target indicator (MTI)), one way to reduce the impact of clutter in RF sensing is to apply Doppler processing to filter out static Doppler components.

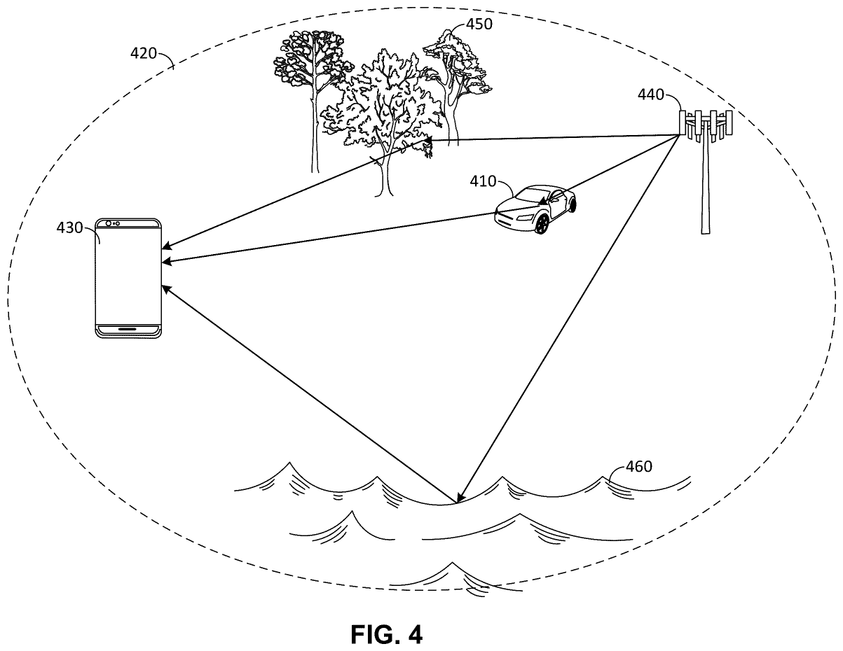

Removing static clutter components, however, may not remove all clutter components these are in some areas. While clutter can be static for some applications (e.g., ground clutter), it can also be moving. That is, clutter can have a non-zero Doppler representation in some scenarios (referred to herein as “clutter Doppler”). For example, an indoor factory environment with large number of moving robotic arms, conveyors, etc. may have a lot of moving more dynamic clutter components. Another example scenario in which clutter may have a non-zero Doppler representation is illustrated in FIG. 4, described below.

FIG. 4 is a simplified diagram illustrating a scenario in which the filtering of static clutter may be insufficient to reduce or eliminate clutter sources for detecting a target 410 in a geographical area 420. In this example, RF sensing is performed using a bistatic configuration in which a UE 430 (an Rx sensing node) performs RF sensing measurements by receiving reflections of RF signal transmissions made by a base station 440 (a Tx sensing node). As noted, the RF sensing is used to detect target 410 (a vehicle). However, the UE 430 also receives reflections from non-static clutter sources, including trees 450 (e.g., being blown in the wind) and waves 460 (e.g., from the ocean). As such, filtering RF measurements from static clutter (having a zero Doppler representation) may be insufficient to remove all clutter that may impede the detection of the object 410. Other such non-static clutter sources may include wind turbines, rain, chaff, airplanes, birds, and more.

To remove non-static clutter sources, such as trees 450 and waves 460, an Rx sensing node may use Doppler characteristics of the non-static clutter sources. However, each geographical area may be different. As such, each geographical area may have a unique profile of clutter Doppler characteristics. Further, it is possible to have multiple clutter Doppler profiles or a single geographical area because clutter Doppler can change over time (e.g., time of day, time of year, etc.). Thus, clutter rejection in a geographical area using Doppler processing can require careful profiling and understanding of underlying clutter Doppler representation.

To address these and other issues, embodiments herein can coordinate RF sensing using sensing nodes in a geographical area to obtain information regarding clutter Doppler and determine a clutter Doppler profile for the geographical area. This may be done at different times of day, different seasons, etc., to determine how the profile might change over time. When a clutter Doppler profile is created for a geographical area, it may then be shared with one or more sensing nodes in the geographical area, which may be new to the geographical area, so that accurate Doppler processing (specifically, clutter rejection) can be used when performing RF sensing. Among other advantages, this can enhance target detection, particularly of long-range targets. The coordination of RF sensing, determination of a clutter Doppler profile, and sharing of the clutter Doppler profile with sensing nodes may be performed by a configuring device. The configuring device may comprise an existing server or function within a network (e.g., the SnMF 221 or LMF 220 of FIG. 2).

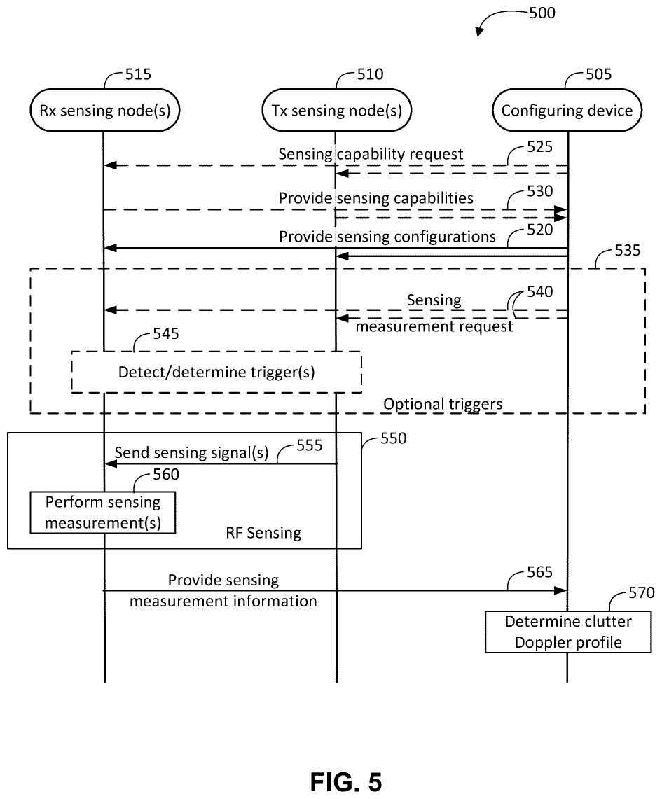

FIG. 5 is a message flow diagram 500 of an example process by which clutter Doppler characteristics of a geographical area for RF sensing may be profiled, according to an embodiment. In this example, the entities involved include a configuring device 505, one or more Tx sensing nodes 510, and one or more Rx sensing nodes 515. As previously noted, when implemented in a cellular network (e.g., 4G, 5G, 6G, etc.), the configuring device 505 may comprise a server or function within the network. This may comprise a device in the core network (e.g., the SnMF 221 or LMF 220 of FIG. 2) and/or RAN (e.g., gNB 210 for the base station, which, in some embodiments, may execute functionality similar to the SnMF 221 or LMF 220 as described above).

For illustrative purposes, the example of FIG. 5 has distinguished the Tx sensing node(s) 510 and the Rx sensing node(s) 515 (which may be referred to herein collectively as “RF sensing node(s) 510, 515”). However, embodiments are not so limited. As previously noted, embodiments may utilize monostatic sensing, in which case a single sensing node may perform both transmitting and receiving. In such cases, a sensing node performing monostatic sensing may perform the functionality of both the Tx sensing node(s) 510 and the Rx sensing node(s) 515. Moreover, in such cases, some functions may be consolidated to help increase efficiency. In general, sensing nodes can be utilized in monostatic and/or multi-static sensing, and may therefore interact with a configuring device accordingly.

According to some embodiments, the process of determining a clutter Doppler profile for a geographical area illustrated by flow diagram 500 may begin with the functionality shown by arrows 520, in which the configuring device 505 sends sensing configurations to the Tx sensing node(s) 510 and the Rx sensing node(s) 515. These configurations can enable the sensing nodes to perform RF sensing in the geographical area and report back RF sensing measurements of clutter Doppler. More specifically, these configurations can configure the Tx sensing node(s) 510 to send a set of sensing signals (i.e., sensing reference signals) and configure the Rx sensing node(s) 515 to receive the set of sensing signals, perform a set of clutter Doppler measurements, and report the clutter Doppler measurements configuring device 505. As such, the configurations can specify various aspects of the sensing signals used, such as signal types, timing, frequency, and the like. Further, as described in more detail below, sensing configurations may also specify triggers with respect to when RF sensing should be performed and/or when RF sensing measurements should be reported. Further, the sensing configurations sent by the configuring device 505 at arrow 520 may be sent while the RF sensing node(s) 510, 515 are in the geographical area and/or prior to the RF sensing node(s) 510, 515 entering the geographical area.

It can be noted that the way in which sensing configurations is provided may vary, depending on desired functionality. For example, according to some embodiments, providing sensing configurations (e.g., as illustrated at arrow 520) may comprise sending the configurations from the configuring device 505 to each of the RF sensing node(s) 510, 515 via LPP or a similar protocol. According to some embodiments, the configurations from the configuring device 505 may be related to sensing nodes via a positioning system information block (POS-SIB). Additionally or alternatively, sensing configurations for devices in a geographical area may be broadcast (e.g., by base stations) in and/or near to the geographical area. Further, according to some embodiments, sensing nodes may request the sensing configuration (e.g., prior to the capability exchange at arrows 525 and 530), which may initiate the providing of the sensing configurations (e.g., via unicast, broadcast, or broadcast) at arrows 520.

Depending on desired functionality, sensing configurations may be sent after an initial capability exchange, illustrated by arrows 525 and 530. (In the figures attached hereto, arrows and boxes represented with dashed lines may indicate optional functionality.) In the capability exchange, the configuring device 505 may send a capability request to the RF sensing node(s) 510, 515, illustrated by arrows 525, to which the RF sensing node(s) 510, 515 respond by providing sensing capabilities, illustrated by arrows 530. Depending on desired functionality, the capability request may request specific capabilities with regard to sensing (e.g., RF sensing transmission and/or measurement capabilities) or may be a general request to provide all relevant sensing capabilities. The sensing capabilities provided by the RF sensing node(s) 510, 515 may provide the relevant information responsive to the request. The sensing capabilities may include, for example, supported measurement triggers, reporting options, types of clutter Doppler measurements, or the like.

As illustrated in block 535, embodiments may include one or more optional triggers that may trigger RF sensing node(s) 510, 515 to perform RF sensing. (Again, these triggers may be specified in the sensing configurations communicated at arrows 520.) One trigger may comprise the configuring device 505 sending a sensing measurement request to the Tx sensing node(s) 510 and/or Rx sensing node(s) 515, indicated at arrow 540. Additionally or alternatively, the RF sensing node(s) 510, 515 may detect or determine one or more triggers, as indicated at optional block 545. These triggers may comprise particular timing (e.g., based on a schedule and/or periodicity) or event-based triggers. According to some embodiments, event-based triggers may comprise the detection of signal characteristics that represent a change in Doppler clutter for a threshold amount of detected Doppler clutter. For example, according to some embodiments, event-based triggers may comprise a change in signal to interference and noise ratio (SINR), RSRP, and/or delay spread beyond the threshold. If a trigger is determined/detected by the RF sensing node(s) 510, 515, it can prompt the subsequent functionality illustrated in FIG. 5. According to some embodiments, in instances in which multiple sensing nodes are used, if one sensing node detects or determines a trigger, it may then share the detection/determination of the trigger with the one or more additional sensing nodes used for performing RF sensing.

The operations in block 550 comprise the RF sensing procedure performed by the RF sensing node(s) 510, 515. Specifically, the RF sensing procedure comprises Tx sensing node(s) 510 transmitting one or more sensing signals, indicated at arrow 555, and Rx sensing node(s) 515 performing one or more sensing measurements, indicated at block 560. As previously noted, sensing signals may include, but are not limited to, a positioning reference signal (PRS), sounding reference signal (SRS), synchronization signal block (SSB), channel start information reference signal (CSI-RS), or any combination thereof. As noted above, sensing measurements can be indicative of reflections (echoes) of the sensing signals transmitted by the Tx sensing node(s) 510 off of one or more objects, which may include one or more targets and/or clutter. To facilitate the profiling of clutter Doppler of the geographical area, the measurements performed at block 560 can include measurements of clutter Doppler. Specific measurements may include, for example, a Doppler-range map, a beam-Doppler-range data cube (e.g., where a beam comprises a Tx beam of a Tx sensing node 510), an angle-Doppler-range data cube, a probability distribution that indicates the shape of clutter Doppler spectrum, a percentile of Doppler information on a range and/or beam level (e.g., median), or the like. Because measurements may vary across different frequencies or frequency bands, sensing measurement information can include which frequency/frequencies or frequency band(s) was/were used when taking the measurements. The RF sensing performed at block 550 can be in accordance with the sensing configurations received from the configuring device 505 at arrows 520. As such, the RF sensing performed at block 550 may include triggers (e.g., shown in block 535), timing, and/or other aspects that are set forth in the sensing configurations.

Rx sensing node(s) 515 may then provide sensing measurement information (reflective of clutter Doppler) to the configuring device 505, as indicated at arrow 565. Similar to the RF sensing performed at block 550, the reporting of sensing measurement information at arrow 565 may be performed in accordance with reporting information included in the sensing configurations at arrows 520. For example, reporting may have optional triggers similar to triggers used for RF sensing (e.g., those illustrated in block 535). Specific triggers for a particular sensing node may include, for example, periodic and/or scheduled reporting, reporting in response to a request by the configuring device 505 (or other device, server, or function), reporting clutter Doppler measurements for a given range, Doppler, and/or angle combination only if its spectrum/power exceeds a threshold, or the like.

According to some embodiments, the sensing measurement information provided at arrow 565 may be accompanied by other information that may be pertinent to the interpretation/processing of the sensing measurement information. For example, because sensing nodes may be mobile (e.g., smart phones, vehicles, or other types of mobile devices), Rx sensing node(s) 515 may include velocity information of the Rx sensing node(s) 515 (and/or Tx sensing node(s) 510, if known) to the configuring device 505. According to some embodiments, Tx sensing node(s) 510 may report velocity information additionally or alternatively (not shown in FIG. 5). Velocity information may be obtained using sensors on a mobile device (e.g., IMU sensors, speedometer, etc.).

At block 570, the configuring device 505 may then use the sensing measurement information to determine a clutter Doppler profile. According to some embodiments, the determination of the clutter Doppler profile may be based on a large number of sensing measurements. In other words, the process shown in flowchart 500 may be executed several times before the configuring device 505 has sufficient information to determine a clutter Doppler profile of a geographical area. As noted previously, clutter Doppler may originate from different sources and may vary over time. As such, the configuring device 505 may obtain sensing measurement information using the process shown in FIG. 5 periodically (e.g., hourly, daily, weekly, monthly, etc.) to amass historical data regarding clutter Doppler of a given geographical area, then determine a suitable clutter Doppler profile based on the information. The periodicity (or other frequency) by which sensing measurement information is obtained by the triggering device 505 may vary depending on location, season, etc. Some locations, for example, may have clutter Doppler that varies more frequently than other locations, and therefore the clutter Doppler profile may be updated more frequently.

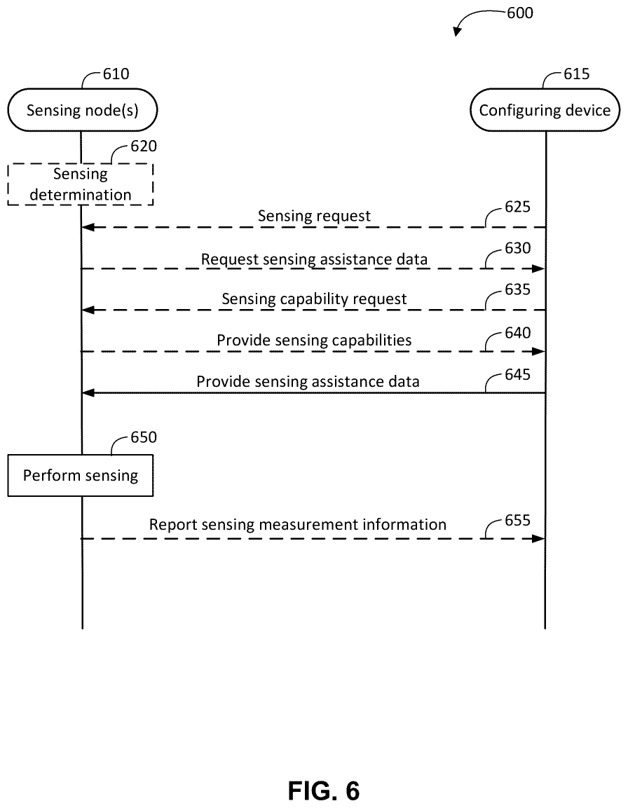

Once created, the clutter Doppler profile may then be sent to one or more RF sensing nodes in the geographical area to perform RF sensing. An example of such a process is illustrated in FIG. 6.

FIG. 6 is a message flow diagram 600 of an example process by which a clutter Doppler profile of a geographical area may be obtained and used by one or more sensing nodes 610 to perform RF sensing in the geographical area. For simplicity, a single set of one or more sensing nodes 610 is illustrated. However, in some instances, sensing nodes may comprise Rx sensing nodes and Tx sensing nodes in a manner similar to that illustrated in FIG. 5. Thus, embodiments may utilize a modified version of the process illustrated in FIG. 6 to provide for communication between the configuring device 615 and Rx/Tx sensing nodes. Again, arrows represented with dashed lines may represent optional functionality. Further, the configuring device 615 may correspond with the configuring device 505 of FIG. 5 (which may be, for example, SnMF 221 or LMF 220 of FIG. 2).

The process in FIG. 6 may begin with the sensing determination at block 620 or a sensing request shown by arrow 625. For example, sensing node-initiated RF sensing may be based on user input, one or more applications executed at the sensing node(s) 610, or the like, in which case the sensing nodes 610 may make the sensing determination shown at block 620. On the other hand, network-initiated RF sensing may be initiated by the configuring device 615, another device or function within a network (e.g., a cellular network), a client communicatively coupled with the network (e.g., external client or AF 230 in FIG. 2), or the like.

In instances in which the sensing node(s) 610 make the sensing determination at block 620, the sensing node(s) 610 may then send a request for sensing assistance data, as indicated at arrow 630. Further, the sensing node(s) 610 may specifically request a clutter Doppler profile of a geographical area to be included in the assistance data. It can be noted that, if the sensing node(s) 610 determines that it already has a valid clutter Doppler profile, it therefore may not need to request the clutter Doppler profile.

Further, depending on desired functionality, a capability exchange may take place, as indicated by arrows 635 and 640. Specifically, the configuring device 615 may request sensing capabilities of the sensing node(s) 610, as indicated at arrow 635, and the sensing node(s) 610 may reply by providing the sensing capabilities, as indicated at arrow 640. With respect to the clutter Doppler profile, the sensing capabilities may indicate which clutter Doppler measurements or characteristics may be utilized by the sensing node(s) 610. As such, the configuring device 615 may include such measurements or characteristics in the subsequently provided assistance data, and may omit other information that the sensing node(s) 610 may not be capable of utilizing.

As indicated by arrow 645, the configuring device 615 may then provide the sensing node(s) 610 with sensing assistance data, including the clutter Doppler profile for a geographical area (e.g., a geographical area the sensing node(s) 610 is in or near, or a geographical area for which the sensing node(s) 610 requested assistance data). The clutter Doppler profile included in the assistance data may describe the clutter Doppler characteristics of a geographical area in various ways. This can include, for example, a Doppler-range map, a beam-Doppler-range data cube, an angle-Doppler-range data cube, a probability distribution that indicates the shape of clutter Doppler spectrum, a percentile of Doppler information on range and beam level (e.g., median), or the like. The clutter Doppler characteristics provided in a clutter Doppler profile may be based on a single set of measurements, multiple sets of measurements (e.g., an average over time), or the like. According to some embodiments, the clutter Doppler profile may include measurements themselves (although such implementations may come at a high cost in terms of overhead). As previously noted, clutter Doppler a very depending on the frequency/frequencies or frequency band(s) used. As such, the clutter Doppler profile included in the assistance data may include frequency information.

The configuring device 615 of FIG. 6 may provide the sensing assistance data in different ways, similar to how the configuring device 505 of FIG. 5 can provide the sensing configurations (shown by arrows 520), described above. For example, according to some embodiments, providing sensing assistance data (e.g., as illustrated at arrow 645) may comprise sending the assistance data from the configuring device 615 to the sensing node(s) 610 via LPP or a similar protocol. Additionally or alternatively, sensing assistance data for devices in a geographical area may be broadcast (e.g., by base stations) or group cast to devices in and/or near to the geographical area.

At block 650, the sensing node(s) 610 may then perform sensing, which may be done in accordance with the sensing assistance data received at arrow 645. As such, the sensing node(s) 610 may perform clutter rejection based on the clutter Doppler profile. Optionally, as shown by arrow 655, the sensing node(s) 610 may report sensing measurement information to the configuring device 615. (This reporting may be the case, for example, if the configuring device 615 provides the sensing node(s) 610 with the sensing request at arrow 625.)

As previously noted, a configuring device may determine a validity of a clutter Doppler profile of a geographical area, based on historical clutter Doppler measurements of the geographical area. A geographical area that historically has clutter Doppler that changes on an hourly basis, for example, may have a clutter Doppler profile that is valid for only an hour. In contrast, a geographical area that has relatively unchanging clutter Doppler may have a clutter Doppler profile that is valid for one month or longer. The configuring device 615 may include this validity information in the sensing assistance data provided at arrow 645. Additionally or alternatively to temporal validity, the configuring device 615 may include spatial validity, indicating area(s) within a geographical region for which the clutter Doppler profile is valid and/or area(s) within the geographical region for which the clutter Doppler profile is not valid.

Device 505 may obtain sensing measurement information using the process shown in FIG. 5 periodically (e.g., hourly, daily, weekly, monthly, etc.) to amass historical data regarding clutter Doppler of a given geographical area, then determine a suitable clutter Doppler profile based on the information. The periodicity (or other frequency) by which sensing measurement information is obtained by the triggering device 505 may vary depending on location, season, etc. Some locations, for example, may have clutter Doppler that varies more frequently than other locations, and therefore the clutter Doppler profile may be updated more frequently.

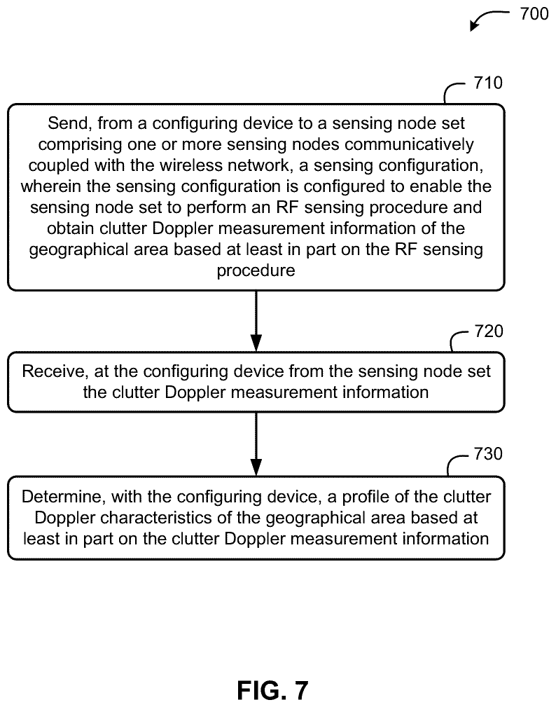

FIG. 7 is a flow diagram of a method 700 of profiling clutter Doppler characteristics of a geographical area for RF sensing by sensing nodes communicatively coupled with a wireless network, according to an embodiment. Means for performing the functionality illustrated in one or more of the blocks shown in FIG. 7 may be performed by hardware and/or software components of a configuring device. Aspects of the method 700 of FIG. 7 may correspond with the functionality of the configuring device 505 in FIG. 5, described above. A configuring device may be implemented by different device types, depending on circumstances. As such, a configuring device may comprise a mobile sensing node, stationary sensing node, or computer system. Example components of a mobile sensing node, stationary sensing node, and computer system are illustrated in FIGS. 10, 11, and 12, respectively, which are described in more detail below.

At block 710, the functionality comprises sending, from a configuring device to a sensing node set comprising one or more sensing nodes communicatively coupled with the wireless network, a sensing configuration, wherein the sensing configuration is configured to enable the sensing node set to perform an RF sensing procedure and obtain clutter Doppler measurement information of the geographical area based at least in part on the RF sensing procedure. As described in the embodiments above, according to some embodiments, the wireless network may comprise a cellular network, such as a 4G, 5G, or 6G network. In such embodiments, the configuring device may comprise a sensing management function (SnMF) or a location management function (LMF) of the cellular network. Further, the one or more sensing nodes may comprise one or more user equipments (UEs), one or more base stations, or both. As described herein, the one or more sensing nodes may comprise Rx and Tx sensing nodes. However, there may be instances in which one or more sensing nodes perform monostatic RF sensing. In such embodiments, the sensing node set may comprise a single sensing node, and the sensing configuration may enable the single sensing node to perform the RF sensing procedure in a monostatic configuration. Further, according to some embodiments, an exchange of capabilities may be performed prior to RF sensing. As such, some embodiments of the method 700 may further comprise, prior to sending the sensing configuration, determining the sensing configuration based at least in part on capability information received from the sensing node set.

As also noted herein, the sensing configuration may include one or more triggers for performing RF sensing and/or reporting measurement information. As such, some embodiments may further comprise including, in the sensing configuration, an indication of one or more triggers to initiate the performing of the RF sensing procedure by the sensing node set. In such embodiments, the one or more triggers may comprise a schedule or periodicity, a subsequent request from the configuring device, one or more event-based triggers, or any combination thereof. Additionally or alternatively, embodiments may comprise including, in the sensing configuration, an indication of one or more reporting triggers to cause the sensing node set to report the clutter Doppler measurement information to the configuring device. In such embodiments, the one or more reporting triggers may comprise a schedule or periodicity, a subsequent request from the configuring device, one or more event-based triggers, or any combination thereof. In such embodiments, the one or more event-based triggers may comprise reporting the clutter Doppler measurement information when a power of one or more measurements of the clutter Doppler measurement information exceeds a threshold.

As previously indicated, the sensing configuration may indicate the types of RF signals to use in RF sensing. Thus, some embodiments may further comprise including, in the sensing configuration, an indication of one or more RF signals to be used for the RF sensing procedure. In such embodiments, the one or more RF signals may comprise a positioning reference signal (PRS), sounding reference signal (SRS), synchronization signal block (SSB), channel start information reference signal (CSI-RS), or any combination thereof.

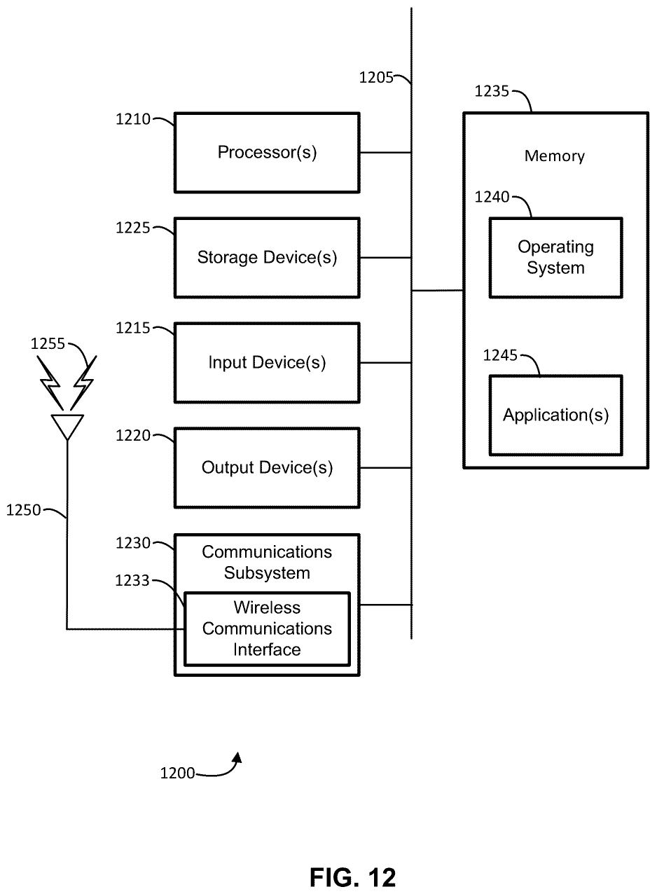

Means for performing functionality at block 710 may comprise a bus 1005, one or more processors 1010, DSP 1020, one or more memories 1060, wireless communication interface 1030, and/or other components of a mobile sensing node 1000, as illustrated in FIG. 10. Additionally or alternatively, means for performing functionality at block 710 may comprise a bus 1105, one or more processors 1110, DSP 1120, one or more memories 1160, wireless communication interface 1130, and/or other components of a stationary sensing node 1100, as illustrated in FIG. 11. Additionally or alternatively, means for performing functionality at block 710 may comprise a bus 1205, one or more processors 1210, one or more memories 1235, communications subsystem 1230 (including wireless communications interface 1233), and/or other components of a computer system 1200, as illustrated in FIG. 12.

At block 720, the functionality comprises receiving, at the configuring device from the sensing node set the clutter Doppler measurement information. As described herein, the clutter Doppler measurement information may enable the configuring device to profile the geographical area in which the clutter Doppler measurement information was measured to be able to profile clutter Doppler in the geographical area. As noted, according to some embodiments, the clutter Doppler measurement information may comprise a Doppler-range map, an angle-Doppler-range data cube, a beam-Doppler-range data cube, a probability distribution that indicates a shape of a clutter Doppler spectrum (e.g., across frequency), a percentile of Doppler information on range and beam level, or any combination thereof. Additionally or alternatively, the clutter Doppler measurement information may comprise an indication of a velocity of at least one sensing node of the sensing node set, an indication of a frequency band with which the RF sensing procedure was performed, or both.

Means for performing functionality at block 720 may comprise a bus 1005, one or more processors 1010, DSP 1020, one or more memories 1060, wireless communication interface 1030 (including RF sensing system 1035), and/or other components of a mobile sensing node 1000, as illustrated in FIG. 10. Additionally or alternatively, means for performing functionality at block 720 may comprise a bus 1105, one or more processors 1110, DSP 1120, one or more memories 1160, wireless communication interface 1130 (including RF sensing system 1135), and/or other components of a stationary sensing node 1100, as illustrated in FIG. 11. Additionally or alternatively, means for performing functionality at block 720 may comprise a bus 1205, one or more processors 1210, one or more memories 1235, communications subsystem 1230 (including wireless communications interface 1233), and/or other components of a computer system 1200, as illustrated in FIG. 12.

At block 730, the functionality comprises determining, with the configuring device, a profile of the clutter Doppler characteristics of the geographical area based at least in part on the clutter Doppler measurement information. As noted in the embodiments discussed above, this determination may be made based on clutter Doppler measurement information taken at different times and/or dates within the geographical area. This may involve different sensing node sets. By doing this, the configuring device can profile the clutter Doppler in the geographical area, and further determine a validity of the clutter Doppler profile (e.g., a range of time, location(s) within the geographical area, etc.).

Means for performing functionality at block 730 may comprise a bus 1005, one or more processors 1010, DSP 1020, one or more memories 1060, and/or other components of a mobile sensing node 1000, as illustrated in FIG. 10. Additionally or alternatively, means for performing functionality at block 730 may comprise a bus 1105, one or more processors 1110, DSP 1120, one or more memories 1160, and/or other components of a stationary sensing node 1100, as illustrated in FIG. 11. Additionally or alternatively, means for performing functionality at block 730 may comprise a bus 1205, one or more processors 1210, one or more memories 1235, and/or other components of a computer system 1200, as illustrated in FIG. 12.

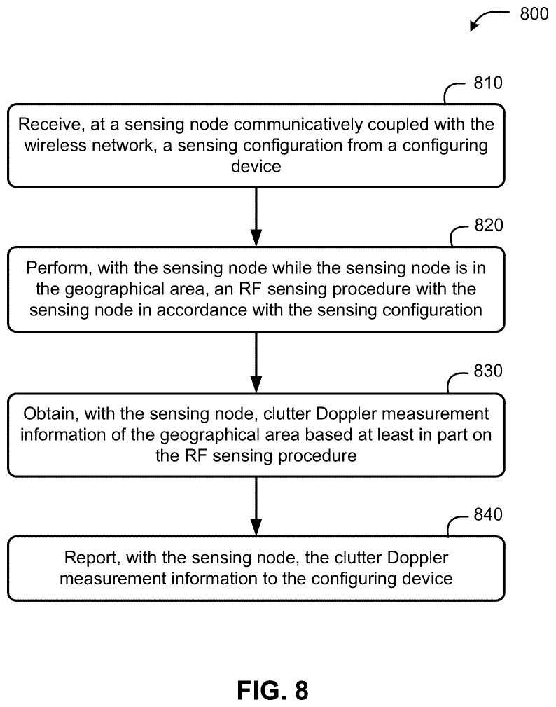

FIG. 8 is a flow diagram of a method 800 of profiling clutter Doppler characteristics of a geographical area for RF sensing by sensing nodes communicatively coupled with a wireless network, according to an embodiment. Aspects of the method 800 of FIG. 8 may correspond with the functionality of the Rx sensing node(s) 515 and/or Tx sensing node(s) 510 in FIG. 5, described above. Means for performing the functionality illustrated in one or more of the blocks shown in FIG. 8 may be performed by hardware and/or software components of an RF sensing node, which may comprise a mobile sensing node or stationary sensing node. Example components of a mobile sensing node and stationary sensing node are illustrated in FIGS. 10 and 11, respectively, which are described in more detail below.

At block 810, the functionality comprises receiving, at a sensing node communicatively coupled with the wireless network, a sensing configuration from a configuring device. As noted herein, according to some embodiments, the wireless network may comprise a cellular network. In such embodiments, the configuring device may comprise a sensing management function (SnMF) or a location management function (LMF) of the cellular network. Additionally or alternatively, the one or more sensing nodes may comprise one or more user equipments (UEs), one or more base stations, or both. further comprising, prior to receiving the sensing configuration, sending capability information from the sensing node to the configuring device. According to some embodiments, the sensing configuration may enable the sensing node to perform RF sensing in a monostatic configuration. Additionally or alternatively, the sensing configuration may enable the sensing node to perform RF sensing as a Tx sensing node, Rx sensing node, or both.

Means for performing functionality at block 810 may comprise a bus 1005, one or more processors 1010, DSP 1020, one or more memories 1060, wireless communication interface 1030, and/or other components of a mobile sensing node 1000, as illustrated in FIG. 10. Additionally or alternatively, means for performing functionality at block 810 may comprise a bus 1105, one or more processors 1110, DSP 1120, one or more memories 1160, wireless communication interface 1130, and/or other components of a stationary sensing node 1100, as illustrated in FIG. 11.

At block 820, the functionality comprises performing, with the sensing node while the sensing node is in the geographical area, an RF sensing procedure with the sensing node in accordance with the sensing configuration. According to some embodiments, performing the RF sensing procedure with the sensing node in accordance with the sensing configuration may comprise performing one or more measurements of one or more RF signals indicated in the sensing configuration. In such embodiments, the one or more RF signals may comprise a positioning reference signal (PRS), sounding reference signal (SRS), synchronization signal block (SSB), channel start information reference signal (CSI-RS), or any combination thereof. Additionally or alternatively, performing the RF sensing procedure with the sensing node may be in response to one or more triggers. In such embodiments, the one or more triggers may be identified in the sensing configuration. The one or more triggers may comprise a schedule or periodicity, a subsequent request from the configuring device, one or more event-based triggers, or any combination thereof.

Means for performing functionality at block 820 may comprise a bus 1005, one or more processors 1010, DSP 1020, one or more memories 1060, wireless communication interface 1030 (including RF sensing system 1035), and/or other components of a mobile sensing node 1000, as illustrated in FIG. 10. Additionally or alternatively, means for performing functionality at block 820 may comprise a bus 1105, one or more processors 1110, DSP 1120, one or more memories 1160, wireless communication interface 1130 (including RF sensing system 1135), and/or other components of a stationary sensing node 1100, as illustrated in FIG. 11.

At block 830, the functionality comprises obtaining, with the sensing node, clutter Doppler measurement information of the geographical area based at least in part on the RF sensing procedure. The clutter Doppler measurement information may be obtained, for example, from measurements from signals received during the performing of the RF sensing procedure (e.g., at an Rx sensing node). It is possible, however, that an Rx sensing node may send this information to a Tx sensing node, in which case the Tx sensing node may obtain the clutter Doppler information from the Rx sensing node. As noted elsewhere herein, clutter Doppler measurement information may comprise any of a variety of types of information to enable a configuring device to determine a clutter Doppler profile. According to some embodiments, the clutter Doppler measurement information may comprise a Doppler-range map, an angle-Doppler-range data cube, a beam-Doppler-range data cube, a probability distribution that indicates a shape of a clutter Doppler spectrum, a percentile of Doppler information on range and beam level, or any combination thereof.

Means for performing functionality at block 830 may comprise a bus 1005, one or more processors 1010, DSP 1020, one or more memories 1060, wireless communication interface 1030 (including RF sensing system 1035), and/or other components of a mobile sensing node 1000, as illustrated in FIG. 10. Additionally or alternatively, means for performing functionality at block 830 may comprise a bus 1105, one or more processors 1110, DSP 1120, one or more memories 1160, wireless communication interface 1130 (including RF sensing system 1135), and/or other components of a stationary sensing node 1100, as illustrated in FIG. 11.

At block 840, the functionality comprises reporting, with the sensing node, the clutter Doppler measurement information to the configuring device. As noted elsewhere herein, the reporting of clutter Doppler measurement information may be based on one or more triggers, which may be included in the sensing configuration received at the sensing node from the configuring device (e.g., at block 810). Accordingly, in such embodiments, reporting the clutter Doppler measurement information may be in response to one or more reporting triggers. The one or more reporting triggers may be identified in the sensing configuration and may comprise a schedule or periodicity, a subsequent request from the configuring device, one or more event-based triggers, or any combination thereof. In some embodiments, the one or more event-based triggers may comprise reporting the clutter Doppler measurement information when a power of one or more measurements of the clutter Doppler measurement information exceeds a threshold. Additionally or alternatively, some embodiments may comprise including, in the clutter Doppler measurement information an indication of a velocity of the sensing node, an indication of a frequency band with which the RF sensing procedure was performed, or both. As noted elsewhere herein, a velocity may be obtained using one or more sensors of the sensing node and/or one or more sensors communicatively coupled with the sensing node.

Means for performing functionality at block 840 may comprise a bus 1005, one or more processors 1010, DSP 1020, one or more memories 1060, wireless communication interface 1030, and/or other components of a mobile sensing node 1000, as illustrated in FIG. 10. Additionally or alternatively, means for performing functionality at block 840 may comprise a bus 1105, one or more processors 1110, DSP 1120, one or more memories 1160, wireless communication interface 1130, and/or other components of a stationary sensing node 1100, as illustrated in FIG. 11.

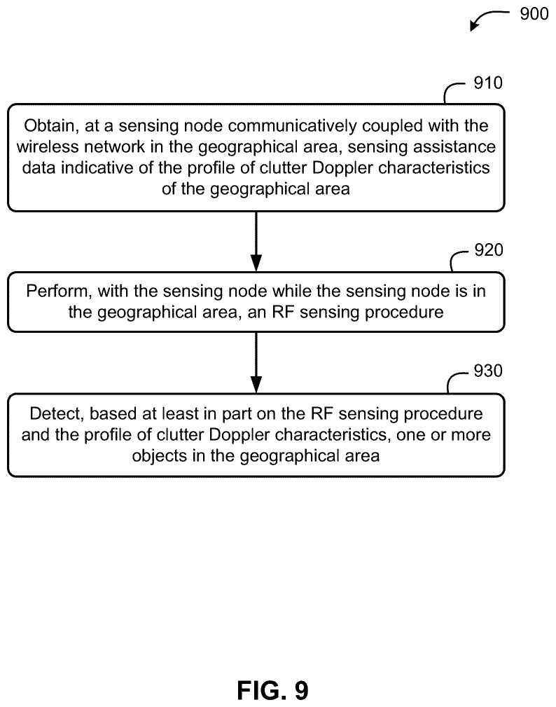

FIG. 9 is a flow diagram of a method 900 of using a profile of clutter Doppler characteristics of a geographical area for RF sensing by a sensing node communicatively coupled with a wireless network, according to an embodiment. Aspects of the method 900 of FIG. 9 may correspond with the functionality of the sensing node(s) 610 of FIG. 6, described above. Means for performing the functionality illustrated in one or more of the blocks shown in FIG. 9 may be performed by hardware and/or software components of an RF sensing node, which may comprise a mobile sensing node or stationary sensing node. Example components of a mobile sensing node and stationary sensing node are illustrated in FIGS. 10 and 11, respectively, which are described in more detail below. The method 900 may be performed once a profile of clutter Doppler characteristics of a geographical area has been determined (e.g., by a configuring device), which may be done in accordance with the methods illustrated in FIGS. 7 and 8, as described above.

At block 910, the functionality comprises obtaining, at a sensing node communicatively coupled with the wireless network in the geographical area, sensing assistance data indicative of the profile of clutter Doppler characteristics of the geographical area. Again, according to some embodiments, the wireless network may comprise a cellular network. In such embodiments, the configuring device may comprise a sensing management function (SnMF) or a location management function (LMF) of the cellular network. Additionally or alternatively, the sensing node may comprise one or more user equipments (UEs), one or more base stations, or both. As indicated previously with respect to FIG. 6, a sensing node may receive sensing assistance data in response to a request for the sensing assistance data. Accordingly, in some embodiments, obtaining the sensing assistance data may be responsive to the sensing node sending a request to a configuring device. Additionally or alternatively, obtaining the sensing assistance data may comprise receiving the sensing assistance data at the sensing node via one or more broadcast messages.

Means for performing functionality at block 910 may comprise a bus 1005, one or more processors 1010, DSP 1020, one or more memories 1060, wireless communication interface 1030, and/or other components of a mobile sensing node 1000, as illustrated in FIG. 10. Additionally or alternatively, means for performing functionality at block 910 may comprise a bus 1105, one or more processors 1110, DSP 1120, one or more memories 1160, wireless communication interface 1130, and/or other components of a stationary sensing node 1100, as illustrated in FIG. 11.

At block 920, the functionality comprises performing, with the sensing node while the sensing node is in the geographical area, an RF sensing procedure. The RF sensing procedure may be based on the assistance data received at block 910, which may include timing, frequency, and/or other information for performing the RF sensing procedure. Additionally, the RF sensing procedure may be performed in accordance with information in the profile of clutter Doppler characteristics, received at block 910. More specifically, the RF sensing procedure may enable clutter rejection and/or cancellation based on the profile of clutter Doppler characteristics. According to some embodiments, the profile of clutter Doppler characteristics may comprise a Doppler-range map, an angle-Doppler-range data cube, a beam-Doppler-range data cube, a probability distribution that indicates a shape of a clutter Doppler spectrum, a percentile of Doppler information on range and beam level, or any combination thereof. According to some embodiments, the assistance data may further comprise an indication of a validity of the profile of clutter Doppler characteristics. In some embodiments, the validity may comprise a period of time during which the profile of clutter Doppler characteristics is valid, at least a portion of the geographical area for which the profile of clutter Doppler characteristics is valid, or both.

Means for performing functionality at block 920 may comprise a bus 1005, one or more processors 1010, DSP 1020, one or more memories 1060, wireless communication interface 1030 (including RF sensing system 1035), and/or other components of a mobile sensing node 1000, as illustrated in FIG. 10. Additionally or alternatively, means for performing functionality at block 920 may comprise a bus 1105, one or more processors 1110, DSP 1120, one or more memories 1160, wireless communication interface 1130 (including RF sensing system 1135), and/or other components of a stationary sensing node 1100, as illustrated in FIG. 11.

At block 930, the functionality comprises detecting, based at least in part on the RF sensing procedure and the profile of clutter Doppler characteristics, one or more objects in the geographical area. Again, this detection may be based on clutter Doppler cancellation enabled by the profile of clutter Doppler characteristics received at block 910. Other information may be included in the sensing assistance data that may facilitate the detection of the one or more objects (e.g., descriptive information such as object type, approximate location, approximate speed/velocity, etc.).

Means for performing functionality at block 930 may comprise a bus 1005, one or more processors 1010, DSP 1020, one or more memories 1060, wireless communication interface 1030 (including RF sensing system 1035), and/or other components of a mobile sensing node 1000, as illustrated in FIG. 10. Additionally or alternatively, means for performing functionality at block 930 may comprise a bus 1105, one or more processors 1110, DSP 1120, one or more memories 1160, wireless communication interface 1130 (including RF sensing system 1135), and/or other components of a stationary sensing node 1100, as illustrated in FIG. 11.

FIG. 10 is a block diagram of an embodiment of a mobile sensing node 1000, which can be utilized as described herein. For example, mobile sensing node 1000 may correspond a mobile device (e.g., mobile device 105 of FIG. 1), UE (e.g., UE 205 of FIG. 2, UE 430 of FIG. 4), sensing node (e.g., Tx sensing node 510 and/or Rx sensing node 515 of FIG. 5, sensing node 610 of FIG. 6), or the like, as described herein. Further, as described below, the mobile sensing node 1000 may implement an RF sensing system 1035, which may correspond to the RF sensing system described above with respect to FIG. 3. Moreover, according to some embodiments, a mobile sensing node 1000 function as a configuring device (e.g., configuring device 505 of FIG. 5, configuring device 615 of FIG. 6), as described herein, in some scenarios. As such, the mobile sensing node 1000 may be capable of performing some or all of the functionality described in the methods shown in FIGS. 7-9. It should be noted that FIG. 10 is meant only to provide a generalized illustration of various components, any or all of which may be utilized as appropriate. Furthermore, as previously noted, the functionality of the UE discussed in the previously described embodiments may be executed by one or more of the hardware and/or software components illustrated in FIG. 10.

The mobile sensing node 1000 is shown comprising hardware elements that can be electrically coupled via a bus 1005 (or may otherwise be in communication, as appropriate). The hardware elements may include a processor(s) 1010 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1010 may comprise one or more processing units, which may be housed in a single integrated circuit (IC) or multiple ICs. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below). The mobile sensing node 1000 also can include one or more input devices 1070, which can include without limitation one or more keyboards, touch screens, touch pads, microphones, buttons, dials, switches, and/or the like; and one or more output devices 1015, which can include without limitation one or more displays (e.g., touch screens), light emitting diodes (LEDs), speakers, and/or the like.

The mobile sensing node 1000 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile sensing node 1000 to communicate and/or perform positioning with other devices as described in the embodiments above, with respect to WLAN and/or cellular technologies. The wireless communication interface 1030 may permit data and signaling to be communicated (e.g., transmitted and received) with NG-RAN nodes of a network, for example, via eNBs, gNBs, ng-eNBs, access points, NTN satellites, various base stations, TRPs, and/or other access node types, and/or other network components, computer systems, and/or any other electronic devices communicatively coupled with TRPs, as described herein. The communication can be carried out via one or more wireless communication antenna(s) 1032 that send and/or receive wireless signals 1034. According to some embodiments, the wireless communication antenna(s) 1032 may comprise a plurality of discrete antennas, antenna arrays, or any combination thereof. The antenna(s) 1032 may be capable of transmitting and receiving wireless signals using beams (e.g., Tx beams and Rx beams). Beam formation may be performed using digital and/or analog beam formation techniques, with respective digital and/or analog circuitry. The wireless communication interface 1030 may include such circuitry.

As noted above, the mobile sensing node 1005 may implement an RF sensing system 1035. The RF sensing system 1035 may comprise the hardware and/or software elements described above with respect to FIG. 3. As illustrated in FIG. 10 and noted above, some or all of the RF sensing system 1035 may be implemented within a wireless communication interface 1030, which may utilize certain components for both communication and RF sensing. That said, embodiments are not so limited. Alternative embodiments may implement some or all of the RF sensing system 1035 separate from the wireless communication interface 1030 (e.g., in cases where RF sensing may utilize different frequencies and/or different hardware/software components then the wireless communication interface 1030).

Depending on desired functionality, the wireless communication interface 1030 may comprise a separate receiver and transmitter, or any combination of transceivers, transmitters, and/or receivers to communicate with base stations (e.g., ng-eNBs and gNBs) and other terrestrial transceivers, such as wireless devices and access points, as well as NTN satellites. The mobile sensing node 1000 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile sensing node 1000 can further include sensor(s) 1040. Sensor(s) 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information. As noted in the description above, sensors 1040 may be used, for example, to determine a velocity of the mobile sensing node, which may be reported to a configuring device, according to some embodiments.

Embodiments of the mobile sensing node 1000 may also include a Global Navigation Satellite System (GNSS) receiver 1080 capable of receiving signals 1084 from one or more GNSS satellites using an antenna 1082 (which could be the same as antenna 1032). Positioning based on GNSS signal measurement can be utilized to complement and/or incorporate the techniques described herein. The GNSS receiver 1080 can extract a position of the mobile sensing node 1000, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1080 is illustrated in FIG. 10 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1010, DSP 1020, and/or a processor within the wireless communication interface 1030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1010 or DSP 1020.

The mobile sensing node 1000 may further include and/or be in communication with a memory 1060. The memory 1060 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1060 of the mobile sensing node 1000 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the mobile sensing node 1000 (and/or processor(s) 1010 or DSP 1020 within mobile sensing node 1000). In some embodiments, then, such code and/or instructions can be used to configure and/or adapt a general-purpose computer (or other device) to perform one or more operations in accordance with the described methods.

FIG. 11 is a block diagram of an embodiment of a stationary sensing node 1100, which can be utilized as described herein. For example, stationary sensing node 1100 may correspond a base station or access node (e.g., base station 120 of FIG. 1, access nodes 110, 210, 214, and 216 of FIG. 2, base station 440 of FIG. 4), sensing node (e.g., Tx sensing node 510 and/or Rx sensing node 515 of FIG. 5, sensing node 610 of FIG. 6), or the like, as described herein. Further, as described below, the stationary sensing node 1100 may implement an RF sensing system 1135, which may correspond to the RF sensing system described above with respect to FIG. 3. Moreover, according to some embodiments, a stationary sensing node 1100 may function as a configuring device (e.g., configuring device 505 of FIG. 5, configuring device 615 of FIG. 6), as described herein, in some scenarios. As such, the stationary sensing node 1100 may be capable of performing some or all of the functionality described in the methods shown in FIGS. 7-9. It should be noted that FIG. 11 is meant only to provide a generalized illustration of various components, any or all of which may be utilized as appropriate. In some embodiments, the stationary sensing node 1100 may correspond to a gNB, an ng-eNB, and/or (more generally) a TRP. In some cases, a stationary sensing node 1100 may comprise multiple TRPs—e.g. with each TRP associated with a different antenna or a different antenna array of the stationary sensing node 1100 (e.g., 1132). As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP.

The functionality performed by a stationary sensing node 1100 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. The functionality of these functional components may be performed by one or more of the hardware and/or software components illustrated in FIG. 11.

The stationary sensing node 1100 is shown comprising hardware elements that can be electrically coupled via a bus 1105 (or may otherwise be in communication, as appropriate). The hardware elements may include a processor(s) 1110 which can include without limitation one or more general-purpose processors, one or more special-purpose processors (such as digital signal processor (DSP) chips, graphics acceleration processors, application-specific integrated circuits (ASICs), and/or the like), and/or other processing structure or means. As shown in FIG. 11, some embodiments may have a separate DSP 1120, depending on desired functionality. Location determination and/or other determinations based on wireless communication may be provided in the processor(s) 1110 and/or wireless communication interface 1130 (discussed below), according to some embodiments. The stationary sensing node 1100 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The stationary sensing node 1100 might also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the stationary sensing node 1100 to communicate as described herein. The wireless communication interface 1130 may permit data and signaling to be communicated (e.g., transmitted and received) to UEs, other base stations/TRPs (e.g., eNBs, gNBs, and ng-eNBs), and/or other network components, computer systems, and/or other electronic devices described herein. The communication can be carried out via one or more wireless communication antenna(s) 1132 that send and/or receive wireless signals 1134. According to some embodiments, one or more wireless communication antenna(s) 1132 may comprise one or more antenna arrays, which may be capable of beamforming.

As noted above, the stationary sensing node 1100 may implement an RF sensing system 1135. The RF sensing system 1135 may comprise the hardware and/or software elements described above with respect to FIG. 3. As illustrated in FIG. 11 and noted above, some or all of the RF sensing system 1135 may be implemented within a wireless communication interface 1130, which may utilize certain components for both communication and RF sensing. That said, embodiments are not so limited. Alternative embodiments may implement some or all of the RF sensing system 1135 separate from the wireless communication interface 1130 (e.g., in cases where RF sensing may utilize different frequencies and/or different hardware/software components then the wireless communication interface 1130).

The stationary sensing node 1100 may also include a network interface 1180, which can include support of wireline communication technologies. The network interface 1180 may include a modem, network card, chipset, and/or the like. The network interface 1180 may include one or more input and/or output communication interfaces to permit data to be exchanged with a network, communication network servers, computer systems, and/or any other electronic devices described herein.

In many embodiments, the stationary sensing node 1100 may further comprise a memory 1160. The memory 1160 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1160 of the stationary sensing node 1100 also may comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the stationary sensing node 1100 (and/or processor(s) 1110 or DSP 1120 within stationary sensing node 1100). In some embodiments, then, such code and/or instructions can be used to configure and/or adapt a general-purpose computer (or other device) to perform one or more operations in accordance with the described methods.

FIG. 12 is a block diagram of an embodiment of a computer system 1200, which may be used, in whole or in part, to provide the functions of one or more components and/or devices as described in the embodiments herein. The computer system 1200, for example, may be utilized within and/or executed by a server (e.g., location server/LMF or sensing server/SnMF), which may perform the functions of a configuring device (e.g., configuring device 505 and/or configuring device 615) as described herein. It should be noted that FIG. 12 is meant only to provide a generalized illustration of various components, any or all of which may be utilized as appropriate. FIG. 12, therefore, broadly illustrates how individual system elements may be implemented in a relatively separated or relatively more integrated manner. In addition, it can be noted that components illustrated by FIG. 12 can be localized to a single device and/or distributed among various networked devices, which may be disposed at different geographical locations.

The computer system 1200 is shown comprising hardware elements that can be electrically coupled via a bus 1205 (or may otherwise be in communication, as appropriate). The hardware elements may include processor(s) 1210, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1200 also may comprise one or more input devices 1215, which may comprise without limitation a mouse, a keyboard, a camera, a microphone, and/or the like; and one or more output devices 1220, which may comprise without limitation a display device, a printer, and/or the like.

The computer system 1200 may further include (and/or be in communication with) one or more non-transitory storage devices 1225, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1200 may also include a communications subsystem 1230, which may comprise wireless communication technologies managed and controlled by a wireless communication interface 1233, as well as wired technologies (such as Ethernet, coaxial communications, universal serial bus (USB), and the like). The wireless communication interface 1233 may comprise one or more wireless transceivers that may send and receive wireless signals 1255 (e.g., signals according to 5G NR or LTE) via wireless antenna(s) 1250. Thus the communications subsystem 1230 may comprise a modem, a network card (wireless or wired), an infrared communication device, a wireless communication device, and/or a chipset, and/or the like, which may enable the computer system 1200 to communicate on any or all of the communication networks described herein to any device on the respective network, including UE, base stations and/or other transmission reception points (TRPs), satellites, and/or any other electronic devices described herein. Hence, the communications subsystem 1230 may be used to receive and send data as described in the embodiments herein.

In many embodiments, the computer system 1200 will further comprise a working memory 1235, which may comprise a RAM or ROM device, as described above. Software elements, shown as being located within the working memory 1235, may comprise an operating system 1240, device drivers, executable libraries, and/or other code, such as one or more applications 1245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1225 described above. In some cases, the storage medium might be incorporated within a computer system, such as computer system 1200. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1200 and/or might take the form of source and/or installable code, which, upon compilation and/or installation on the computer system 1200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1: A method of profiling clutter Doppler characteristics of a geographical area for radio frequency (RF) sensing by sensing nodes communicatively coupled with a wireless network, the method comprising: sending, from a configuring device to a sensing node set comprising one or more sensing nodes communicatively coupled with the wireless network, a sensing configuration, wherein the sensing configuration is configured to enable the sensing node set to perform an RF sensing procedure and obtain clutter Doppler measurement information of the geographical area based at least in part on the RF sensing procedure; receiving, at the configuring device from the sensing node set the clutter Doppler measurement information; and determining, with the configuring device, a profile of the clutter Doppler characteristics of the geographical area based at least in part on the clutter Doppler measurement information.
Clause 2: The method of clause 1, wherein the clutter Doppler measurement information comprises: a Doppler-range map, an angle-Doppler-range data cube, a beam-Doppler-range data cube, a probability distribution that indicates a shape of a clutter Doppler spectrum, a percentile of Doppler information on range and beam level, or any combination thereof.
Clause 3: The method of any one of clauses 1-2 further comprising including, in the sensing configuration, an indication of one or more triggers to initiate the performing of the RF sensing procedure by the sensing node set, wherein the one or more triggers comprise: a schedule or periodicity, a subsequent request from the configuring device, one or more event-based triggers, or any combination thereof.
Clause 4: The method of any one of clauses 1-3 further comprising including, in the sensing configuration, an indication of one or more reporting triggers to cause the sensing node set to report the clutter Doppler measurement information to the configuring device, the one or more reporting triggers comprising: a schedule or periodicity, a subsequent request from the configuring device, one or more event-based triggers, or any combination thereof.
Clause 5: The method of clause 4 wherein the one or more event-based triggers comprises reporting the clutter Doppler measurement information when a power of one or more measurements of the clutter Doppler measurement information exceeds a threshold.
Clause 6: The method of any one of clauses 1-5 further comprising including, in the sensing configuration, an indication of one or more RF signals to be used for the RF sensing procedure, the one or more RF signals comprising: a positioning reference signal (PRS), a sounding reference signal (SRS), a synchronization signal block (SSB), a channel start information reference signal (CSI-RS), or any combination thereof.
Clause 7: The method of any one of clauses 1-6 wherein the sensing node set comprises a single sensing node, and wherein the sensing configuration enables the single sensing node to perform the RF sensing procedure in a monostatic configuration.
Clause 8: The method of any one of clauses 1-7 wherein the wireless network comprises a cellular network and wherein: the configuring device comprises a sensing management function (SnMF) or a location management function (LMF) of the cellular network; and the one or more sensing nodes comprise one or more user equipments (UEs), one or more base stations, or both.
Clause 9: The method of any one of clauses 1-8 further comprising, prior to sending the sensing configuration, determining the sensing configuration based at least in part on capability information received from the sensing node set.
Clause 10: The method of any one of clauses 1-9 wherein the clutter Doppler measurement information comprises: an indication of a velocity of at least one sensing node of the sensing node set, an indication of a frequency band with which the RF sensing procedure was performed, or both.
Clause 11: A method of profiling clutter Doppler characteristics of a geographical area for radio frequency (RF) sensing by sensing nodes communicatively coupled with a wireless network, the method comprising: receiving, at a sensing node communicatively coupled with the wireless network, a sensing configuration from a configuring device; performing, with the sensing node while the sensing node is in the geographical area, an RF sensing procedure with the sensing node in accordance with the sensing configuration; obtaining, with the sensing node, clutter Doppler measurement information of the geographical area based at least in part on the RF sensing procedure; and reporting, with the sensing node, the clutter Doppler measurement information to the configuring device.
Clause 12: The method of clause 11, wherein the clutter Doppler measurement information comprises: a Doppler-range map, an angle-Doppler-range data cube, a beam-Doppler-range data cube, a probability distribution that indicates a shape of a clutter Doppler spectrum, a percentile of Doppler information on range and beam level, or any combination thereof.
Clause 13: The method of any one of clauses 11-12 further comprising performing the RF sensing procedure with the sensing node in response to one or more triggers, wherein the one or more triggers are identified in the sensing configuration and comprise: a schedule or periodicity, a subsequent request from the configuring device, one or more event-based triggers, or any combination thereof.
Clause 14: The method of any one of clauses 11-13 wherein reporting the clutter Doppler measurement information in response to one or more reporting triggers, wherein the one or more reporting triggers are identified in the sensing configuration and comprise: a schedule or periodicity, a subsequent request from the configuring device, one or more event-based triggers, or any combination thereof.
Clause 15: The method of clause 14 wherein the one or more event-based triggers comprises reporting the clutter Doppler measurement information when a power of one or more measurements of the clutter Doppler measurement information exceeds a threshold.
Clause 16: The method of any one of clauses 11-15 wherein performing the RF sensing procedure with the sensing node in accordance with the sensing configuration comprises performing one or more measurements of one or more RF signals indicated in the sensing configuration, the one or more RF signals comprising: a positioning reference signal (PRS), a sounding reference signal (SRS), a synchronization signal block (SSB), a channel start information reference signal (CSI-RS), or any combination thereof.
Clause 17: The method of any one of clauses 11-16 wherein the wireless network comprises a cellular network and wherein: the configuring device comprises a sensing management function (SnMF) or a location management function (LMF) of the cellular network; and the one or more sensing nodes comprise one or more user equipments (UEs), one or more base stations, or both.
Clause 18: The method of any one of clauses 11-17 further comprising, prior to receiving the sensing configuration, sending capability information from the sensing node to the configuring device.
Clause 19: The method of any one of clauses 11-18 further comprising including, in the clutter Doppler measurement information: an indication of a velocity of the sensing node, an indication of a frequency band with which the RF sensing procedure was performed, or both.
Clause 20: A method of using a profile of clutter Doppler characteristics of a geographical area for radio frequency (RF) sensing by a sensing node communicatively coupled with a wireless network, the method comprising: obtaining, at a sensing node communicatively coupled with the wireless network in the geographical area, sensing assistance data indicative of the profile of clutter Doppler characteristics of the geographical area; performing, with the sensing node while the sensing node is in the geographical area, an RF sensing procedure; and detecting, based at least in part on the RF sensing procedure and the profile of clutter Doppler characteristics, one or more objects in the geographical area.
Clause 21: The method of clause 20, wherein the profile of clutter Doppler characteristics comprises: a Doppler-range map, an angle-Doppler-range data cube, a beam-Doppler-range data cube, a probability distribution that indicates a shape of a clutter Doppler spectrum, a percentile of Doppler information on range and beam level, or any combination thereof.
Clause 22: The method of any one of clauses 20-21 wherein the sensing assistance data further comprises an indication of a validity of the profile of clutter Doppler characteristics, the validity comprising: a period of time during which the profile of clutter Doppler characteristics is valid, at least a portion of the geographical area for which the profile of clutter Doppler characteristics is valid, or both.
Clause 23: The method of any one of clauses 20-22 wherein obtaining the sensing assistance data comprises receiving the sensing assistance data at the sensing node via one or more broadcast messages.
Clause 24: The method of any one of clauses 20-23 wherein obtaining the sensing assistance data is responsive to the sensing node sending a request to a configuring device.
Clause 25: The method of clause 24 wherein the wireless network comprises a cellular network and wherein: the configuring device comprises a sensing management function (SnMF) or a location management function (LMF) of the cellular network; and the sensing node comprises one or more user equipments (UEs), one or more base stations, or both.
Clause 26: A configuring device for profiling clutter Doppler characteristics of a geographical area for radio frequency (RF) sensing by sensing nodes communicatively coupled with a wireless network, the configuring device comprising: one or more transceivers; one or more memories; and one or more processors communicatively coupled with the one or more transceivers and the one or more memories, wherein the one or more processors are configured to: send, via the one or more transceivers to a sensing node set comprising one or more sensing nodes communicatively coupled with the wireless network, a sensing configuration, wherein the sensing configuration is configured to enable the sensing node set to perform an RF sensing procedure and obtain clutter Doppler measurement information of the geographical area based at least in part on the RF sensing procedure; receive, via the one or more transceivers from the sensing node set the clutter Doppler measurement information; and determine a profile of the clutter Doppler characteristics of the geographical area based at least in part on the clutter Doppler measurement information.
Clause 27: The configuring device of clause 26, wherein the clutter Doppler measurement information comprises: a Doppler-range map, an angle-Doppler-range data cube, a beam-Doppler-range data cube, a probability distribution that indicates a shape of a clutter Doppler spectrum, a percentile of Doppler information on range and beam level, or any combination thereof.
Clause 28: The configuring device of any one of clauses 26-27 wherein the one or more processors are further configured to include, in the sensing configuration, an indication of one or more triggers to initiate the performing of the RF sensing procedure by the sensing node set, wherein the one or more triggers comprise: a schedule or periodicity, a subsequent request from the configuring device, one or more event-based triggers, or any combination thereof.
Clause 29: The configuring device of any one of clauses 26-28 wherein the one or more processors are further configured to include, in the sensing configuration, an indication of one or more reporting triggers to cause the sensing node set to report the clutter Doppler measurement information to the configuring device, the one or more reporting triggers comprising: a schedule or periodicity, a subsequent request from the configuring device, one or more event-based triggers, or any combination thereof.
Clause 30: The configuring device of any one of clauses 26-29 wherein the one or more event-based triggers comprises reporting the clutter Doppler measurement information when a power of one or more measurements of the clutter Doppler measurement information exceeds a threshold.
Clause 31: The configuring device of any one of clauses 26-30 wherein the one or more processors are further configured to include, in the sensing configuration, an indication of one or more RF signals to be used for the RF sensing procedure, the one or more RF signals comprising: a positioning reference signal (PRS), a sounding reference signal (SRS), a synchronization signal block (SSB), a channel start information reference signal (CSI-RS), or any combination thereof.
Clause 32: The configuring device of any one of clauses 26-31 wherein the sensing node set comprises a single sensing node, and wherein the sensing configuration enables the single sensing node to perform the RF sensing procedure in a monostatic configuration.
Clause 33: The configuring device of any one of clauses 26-32 wherein the wireless network comprises a cellular network and wherein: the configuring device comprises a sensing management function (SnMF) or a location management function (LMF) of the cellular network; and the one or more sensing nodes comprise one or more user equipments (UEs), one or more base stations, or both.
Clause 34: The configuring device of any one of clauses 26-33 wherein the one or more processors are further configured to, prior to sending the sensing configuration, determine the sensing configuration based at least in part on capability information received from the sensing node set.
Clause 35: The configuring device of any one of clauses 26-34 wherein the clutter Doppler measurement information comprises: an indication of a velocity of at least one sensing node of the sensing node set, an indication of a frequency band with which the RF sensing procedure was performed, or both.
Clause 36: A sensing node for profiling clutter Doppler characteristics of a geographical area for radio frequency (RF) sensing by sensing nodes communicatively coupled with a wireless network, the sensing node comprising: one or more transceivers; one or more memories; and one or more processors communicatively coupled with the one or more transceivers and the one or more memories, wherein the one or more processors are configured to: receive, via the one or more transceivers, a sensing configuration from a configuring device; perform an RF sensing procedure with the sensing node in accordance with the sensing configuration while the sensing node is in the geographical area; obtain clutter Doppler measurement information of the geographical area based at least in part on the RF sensing procedure; and report, via the one or more transceivers, the clutter Doppler measurement information to the configuring device.
Clause 37: The sensing node of clause 36, wherein the clutter Doppler measurement information comprises: a Doppler-range map, an angle-Doppler-range data cube, a beam-Doppler-range data cube, a probability distribution that indicates a shape of a clutter Doppler spectrum, a percentile of Doppler information on range and beam level, or any combination thereof.
Clause 38: The sensing node of any one of clauses 36-37 wherein the one or more processors are further configured to perform the RF sensing procedure with the sensing node in response to one or more triggers, wherein the one or more triggers are identified in the sensing configuration and comprise: a schedule or periodicity, a subsequent request from the configuring device, one or more event-based triggers, or any combination thereof.
Clause 39: The sensing node of any one of clauses 36-38 wherein reporting the clutter Doppler measurement information in response to one or more reporting triggers, wherein the one or more reporting triggers are identified in the sensing configuration and comprise: a schedule or periodicity, a subsequent request from the configuring device, one or more event-based triggers, or any combination thereof.
Clause 40: The sensing node of clause 39 wherein the one or more event-based triggers comprises reporting the clutter Doppler measurement information when a power of one or more measurements of the clutter Doppler measurement information exceeds a threshold.
Clause 41: The sensing node of any one of clauses 36-40 wherein, to perform the RF sensing procedure with the sensing node in accordance with the sensing configuration, the one or more processors are configured to perform one or more measurements of one or more RF signals indicated in the sensing configuration, the one or more RF signals comprising a positioning reference signal (PRS), a sounding reference signal (SRS), a synchronization signal block (SSB), a channel start information reference signal (CSI-RS), or any combination thereof.
Clause 42: The sensing node of any one of clauses 36-41 wherein the wireless network comprises a cellular network and wherein: the configuring device comprises a sensing management function (SnMF) or a location management function (LMF) of the cellular network; and the one or more sensing nodes comprise one or more user equipments (UEs), one or more base stations, or both.
Clause 43: The sensing node of any one of clauses 36-42 wherein the one or more processors are further configured to, prior to receiving the sensing configuration, send capability information from the sensing node to the configuring device.
Clause 44: The sensing node of any one of clauses 36-43 wherein the one or more processors are further configured to include, in the clutter Doppler measurement information: an indication of a velocity of the sensing node, an indication of a frequency band with which the RF sensing procedure was performed, or both.
Clause 45: A sensing node for using a profile of clutter Doppler characteristics of a geographical area for radio frequency (RF) sensing, the sensing node comprising: one or more transceivers; one or more memories; and one or more processors communicatively coupled with the one or more transceivers and the one or more memories, wherein the one or more processors are configured to: obtain sensing assistance data indicative of the profile of clutter Doppler characteristics of the geographical area; perform an RF sensing procedure with the sensing node while the sensing node is in the geographical area; and detect, based at least in part on the RF sensing procedure and the profile of clutter Doppler characteristics, one or more objects in the geographical area.
Clause 46: The sensing node of clause 45, wherein the profile of clutter Doppler characteristics comprises: a Doppler-range map, an angle-Doppler-range data cube, a beam-Doppler-range data cube, a probability distribution that indicates a shape of a clutter Doppler spectrum, a percentile of Doppler information on range and beam level, or any combination thereof.
Clause 47: The sensing node of any one of clauses 45-46 wherein the sensing assistance data further comprises an indication of a validity of the profile of clutter Doppler characteristics, the validity comprising: a period of time during which the profile of clutter Doppler characteristics is valid, at least a portion of the geographical area for which the profile of clutter Doppler characteristics is valid, or both.
Clause 48: The sensing node of any one of clauses 45-47 wherein, to obtain the sensing assistance data, the one or more processors are configured to receive the sensing assistance data at the sensing node via one or more broadcast messages.
Clause 49: The sensing node of any one of clauses 45-48 wherein the one or more processors are configured to obtain the sensing assistance data responsive to the sensing node sending a request to a configuring device.
Clause 50: The sensing node of clause 49 wherein a wireless network with which the sensing node is communicatively coupled comprises a cellular network and wherein: the configuring device comprises a sensing management function (SnMF) or a location management function (LMF) of the cellular network; and the sensing node comprises one or more user equipments (UEs), one or more base stations, or both.

An apparatus having means for performing the method of any one of clauses 1-25.

A non-transitory computer-readable medium storing instructions, the instructions comprising code for performing the method of any one of clauses 1-25.

What is claimed is:

1. A method of profiling clutter Doppler characteristics of a geographical area for radio frequency (RF) sensing by sensing nodes communicatively coupled with a wireless network, the method comprising:
sending, from a configuring device to a sensing node set comprising one or more sensing nodes communicatively coupled with the wireless network, a sensing configuration, wherein the sensing configuration is configured to enable the sensing node set to perform an RF sensing procedure and obtain clutter Doppler measurement information of the geographical area based at least in part on the RF sensing procedure;
receiving, at the configuring device from the sensing node set the clutter Doppler measurement information; and
determining, with the configuring device, a profile of the clutter Doppler characteristics of the geographical area based at least in part on the clutter Doppler measurement information.

2. The method of claim 1, wherein the clutter Doppler measurement information comprises:
a Doppler-range map,
an angle-Doppler-range data cube,
a beam-Doppler-range data cube,
a probability distribution that indicates a shape of a clutter Doppler spectrum,
a percentile of Doppler information on range and beam level, or
any combination thereof.

3. The method of claim 1, further comprising including, in the sensing configuration, an indication of one or more triggers to initiate the performing of the RF sensing procedure by the sensing node set, wherein the one or more triggers comprise:
a schedule or periodicity,
a subsequent request from the configuring device,
one or more event-based triggers, or
any combination thereof.

4. The method of claim 1, further comprising including, in the sensing configuration, an indication of one or more reporting triggers to cause the sensing node set to report the clutter Doppler measurement information to the configuring device, the one or more reporting triggers comprising:
a schedule or periodicity,
a subsequent request from the configuring device,
one or more event-based triggers, or
any combination thereof.

5. The method of claim 4, wherein the one or more event-based triggers comprises reporting the clutter Doppler measurement information when a power of one or more measurements of the clutter Doppler measurement information exceeds a threshold.

6. The method of claim 1, further comprising including, in the sensing configuration, an indication of one or more RF signals to be used for the RF sensing procedure, the one or more RF signals comprising:
a positioning reference signal (PRS),
a sounding reference signal (SRS),
a synchronization signal block (SSB),
a channel start information reference signal (CSI-RS), or
any combination thereof.

7. The method of claim 1, wherein the sensing node set comprises a single sensing node, and wherein the sensing configuration enables the single sensing node to perform the RF sensing procedure in a monostatic configuration.

8. The method of claim 1, wherein the wireless network comprises a cellular network and wherein:
the configuring device comprises a sensing management function (SnMF) or a location management function (LMF) of the cellular network; and
the one or more sensing nodes comprise one or more user equipments (UEs), one or more base stations, or both.

9. The method of claim 1, further comprising, prior to sending the sensing configuration, determining the sensing configuration based at least in part on capability information received from the sensing node set.

10. The method of claim 1, wherein the clutter Doppler measurement information comprises:
an indication of a velocity of at least one sensing node of the sensing node set,
an indication of a frequency band with which the RF sensing procedure was performed, or
both.

11. A method of using a profile of clutter Doppler characteristics of a geographical area for radio frequency (RF) sensing by a sensing node communicatively coupled with a wireless network, the method comprising:
obtaining, at a sensing node communicatively coupled with the wireless network in the geographical area, sensing assistance data indicative of the profile of clutter Doppler characteristics of the geographical area;
performing, with the sensing node while the sensing node is in the geographical area, an RF sensing procedure; and
detecting, based at least in part on the RF sensing procedure and the profile of clutter Doppler characteristics, one or more objects in the geographical area.

12. The method of claim 11, wherein the profile of clutter Doppler characteristics comprises:
a Doppler-range map,
an angle-Doppler-range data cube,
a beam-Doppler-range data cube,
a probability distribution that indicates a shape of a clutter Doppler spectrum,
a percentile of Doppler information on range and beam level, or
any combination thereof.

13. The method of claim 11, wherein the sensing assistance data further comprises an indication of a validity of the profile of clutter Doppler characteristics, the validity comprising:
a period of time during which the profile of clutter Doppler characteristics is valid,
at least a portion of the geographical area for which the profile of clutter Doppler characteristics is valid, or
both.

14. The method of claim 11, wherein obtaining the sensing assistance data comprises receiving the sensing assistance data at the sensing node via one or more broadcast messages.

15. The method of claim 11, wherein obtaining the sensing assistance data is responsive to the sensing node sending a request to a configuring device.

16. The method of claim 15, wherein the wireless network comprises a cellular network and wherein:
the configuring device comprises a sensing management function (SnMF) or a location management function (LMF) of the cellular network; and
the sensing node comprises one or more user equipments (UEs), one or more base stations, or both.

17. A configuring device for profiling clutter Doppler characteristics of a geographical area for radio frequency (RF) sensing by sensing nodes communicatively coupled with a wireless network, the configuring device comprising:
one or more transceivers;
one or more memories; and
one or more processors communicatively coupled with the one or more transceivers and the one or more memories, wherein the one or more processors are configured to:
send, via the one or more transceivers to a sensing node set comprising one or more sensing nodes communicatively coupled with the wireless network, a sensing configuration, wherein the sensing configuration is configured to enable the sensing node set to perform an RF sensing procedure and obtain clutter Doppler measurement information of the geographical area based at least in part on the RF sensing procedure;
receive, via the one or more transceivers from the sensing node set the clutter Doppler measurement information; and
determine a profile of the clutter Doppler characteristics of the geographical area based at least in part on the clutter Doppler measurement information.

18. The configuring device of claim 17, wherein the clutter Doppler measurement information comprises:
a Doppler-range map,
an angle-Doppler-range data cube,
a beam-Doppler-range data cube,
a probability distribution that indicates a shape of a clutter Doppler spectrum,
a percentile of Doppler information on range and beam level, or
any combination thereof.

19. The configuring device of claim 17, wherein the one or more processors are further configured to include, in the sensing configuration, an indication of one or more triggers to initiate the performing of the RF sensing procedure by the sensing node set, wherein the one or more triggers comprise:
a schedule or periodicity,
a subsequent request from the configuring device,
one or more event-based triggers, or
any combination thereof.

20. The configuring device of claim 17, wherein the one or more processors are further configured to include, in the sensing configuration, an indication of one or more reporting triggers to cause the sensing node set to report the clutter Doppler measurement information to the configuring device, the one or more reporting triggers comprising:
a schedule or periodicity,
a subsequent request from the configuring device,
one or more event-based triggers, or
any combination thereof.

21. The configuring device of claim 20, wherein the one or more event-based triggers comprises reporting the clutter Doppler measurement information when a power of one or more measurements of the clutter Doppler measurement information exceeds a threshold.

22. The configuring device of claim 17, wherein the one or more processors are further configured to include, in the sensing configuration, an indication of one or more RF signals to be used for the RF sensing procedure, the one or more RF signals comprising:
a positioning reference signal (PRS),
a sounding reference signal (SRS),
a synchronization signal block (SSB),
a channel start information reference signal (CSI-RS), or
any combination thereof.

23. The configuring device of claim 17, wherein the wireless network comprises a cellular network and wherein:
the configuring device comprises a sensing management function (SnMF) or a location management function (LMF) of the cellular network; and
the one or more sensing nodes comprise one or more user equipments (UEs), one or more base stations, or both.

24. The configuring device of claim 17, wherein the one or more processors are further configured to, prior to sending the sensing configuration, determine the sensing configuration based at least in part on capability information received from the sensing node set.

25. The configuring device of claim 17, wherein the clutter Doppler measurement information comprises:
an indication of a velocity of at least one sensing node of the sensing node set,
an indication of a frequency band with which the RF sensing procedure was performed, or
both.

26. A sensing node for using a profile of clutter Doppler characteristics of a geographical area for radio frequency (RF) sensing, the sensing node comprising:
one or more transceivers;
one or more memories; and
one or more processors communicatively coupled with the one or more transceivers and the one or more memories, wherein the one or more processors are configured to:
obtain sensing assistance data indicative of the profile of clutter Doppler characteristics of the geographical area;
perform an RF sensing procedure with the sensing node while the sensing node is in the geographical area; and
detect, based at least in part on the RF sensing procedure and the profile of clutter Doppler characteristics, one or more objects in the geographical area.

27. The sensing node of claim 26, wherein the profile of clutter Doppler characteristics comprises:
a Doppler-range map,
an angle-Doppler-range data cube,
a beam-Doppler-range data cube,
a probability distribution that indicates a shape of a clutter Doppler spectrum,
a percentile of Doppler information on range and beam level, or
any combination thereof.

28. The sensing node of claim 26, wherein the sensing assistance data further comprises an indication of a validity of the profile of clutter Doppler characteristics, the validity comprising:
a period of time during which the profile of clutter Doppler characteristics is valid,
at least a portion of the geographical area for which the profile of clutter Doppler characteristics is valid, or
both.

29. The sensing node of claim 26, wherein, to obtain the sensing assistance data, the one or more processors are configured to receive the sensing assistance data at the sensing node via one or more broadcast messages.

30. The sensing node of claim 26, wherein the one or more processors are configured to obtain the sensing assistance data responsive to the sensing node sending a request to a configuring device.
